(19) United States
(12) Patent Application Publication
(10) Pub. No.: US 2013/0191898 A1
(43) Pub. Date: Jul. 25, 2013

(54) IDENTITY VERIFICATION CREDENTIAL WITH CONTINUOUS VERIFICATION AND INTENTION-BASED AUTHENTICATION SYSTEMS AND METHODS

(71) Applicant: Harold H. Kraft, Arlington, VA (US)

(72) Inventor: Harold H. Kraft, Arlington, VA (US)

(21) Appl. No.: 13/734,578

(22) Filed: Jan. 4, 2013

Related U.S. Application Data
(60) Provisional application No. 61/583,090, filed on Jan. 4, 2012.

(51) Int. Cl. G06F 21/31

(52) U.S. Cl. CPC G06F 21/31
USPC 726/6

(57) ABSTRACT

A system providing features for facilitating the authentication and verification of a consumer, facilitating and sharing trust between the consumer and third parties, and for continuously updating such information. The system can create an online identity credential based on verifying the identity of an individual subject. The system can include adding first, second, and third party information to the credential, analyzing the data in the credential to create metadata stored within the credential, continuously and periodically updating the elements and metadata of the identity credential, and for sharing selected data and metadata elements of the credential with second and third parties. The system can be used as a standalone identity credential or in support of biometric identity applications. The system can include rewards to encourage subjects to continuously verify their identity. The system can include a Knowledge-Based-Authentication based on intention analysis derived from second-party data, rather than factual third-party data.

### CROSS REFERENCE TO RELATED APPLICATIONS

This application claims the benefit of U.S. Provisional Application No. 61/583,090 filed Jan. 4, 2012, the content of which is hereby incorporated by reference in its entirety

### BACKGROUND

Embodiments relate generally to systems and methods of identification and, more particularly, to systems and methods for facilitating transactions in which verification and/or authentication of the identity of transacting parties, characteristics of the transacting parties, and trust between transacting parties are important components of the transactions.

An individual's identity is the foundation upon which their reputation rests. An identity, and its accompanying reputation, can determine whether a person can be trusted in a given transaction. That transaction can include, for example, boarding an airplane, entering a high-rise office building, using a credit card or debit card to purchase goods, going out on a romantic date with someone from an interne dating site, applying for a loan, asking a health insurance company to reimburse the cost of a medical procedure, applying for a job, being accepted as a volunteer in a position of responsibility, or even giving a recommendation for a friend or colleague.

One component of these issues is the concept of trust. The ability to trust the individual with whom one interacts can facilitate the speed of transactions and can reduce the costs and/or risks of transactions. Trust can have real value in commerce, in social situations, and in personal situations.

As the world turns, identity has shifted from real-world-only transactions to virtual interne-enabled transactions in which anonymity may increase. At the same time, in the post 9/11 era, the need for continual reassessment of identity may become more important. One of the great failures of traditional identification mechanisms such as a physical driver's license or even knowing someone's name, date of birth, and social security number, is that a one-time identity verification without ongoing reassessments can lead to disastrous consequences.

In parallel with the need for more identity verification may be an increase in public awareness of, and resistance to, the Big Brother collection of data. Citizens may demand more control over their own identity, and more ability to understand and control who knows what about them.

As biometric identification becomes more commonplace, the need for identity verification may increase. While this may seem counter-intuitive to some, it is easily explained. Biometric identification can be thought of as simply a key to a lock, except that the key is made up of biologic characteristics of the individual. Biometrics, passwords, and three-factor authentication all answer the question “Are you the same person that I gave the key to a year ago?” Identity verification, on the other hand, answers questions such as, but not limited to, “Are you who you say you are”, “Are you a person who should receive a key in the first place”, and “Just because you possess a password or a piece of plastic, are you really the same person that received the key a year ago?”

There are multiple threats to the accuracy of a person's identity, such as but not limited to: identity theft, which can come in a large range of mechanisms and severities; incorrect attachment of reputational information by third-party agencies (for example government agencies and credit bureaus) that can be the result of clerical error, computer error, and/or as a consequence of identity theft (in internet websites, blogs, and social media outlets such as Twitter, the veracity of reputational information is especially susceptible to fraud); name overlap that can result from sheer quantity, e.g. there are roughly 50,000 John Smiths, and/or it can result from name confusion, e.g. Bob/Bobbi/Bobby/Bobi/Rob/Robert/Robt/Robbie.

While the need for identity verification may be increasing, there may also be a need to make the verification process smoother and less intrusive. And there may be a need to balance between two or more of the following: the verification/reputation requirements, the amount of information that is shared with a transactional party, the speed of verification, and the cost of verification.

There is an emerging field of identity management that covers various related concepts that offer various tools for convenience, privacy, user-control, and/or security. Some in the identity management field foresee an important role for systems that make use of objective information sources that contain information about individuals and other entities and use that information to facilitate transactions. An example is where a user needs to prove some piece of information about himself or herself such as age, state of residence, etc. and authorizes a trusted intermediary to transmit that information to a third party that needs to confirm the information. As such systems become more important, the integrity of the data in the information source may become more important in the lives of any entities who are the subjects of such information and who rely on these intermediary facilities to perform transactions with others. For examples of such systems, see US Patent Publication Nos. 20042802841665 for “Method and system for enroll-thru operations and reprioritization operations in a federated environment;” 20060130065 for “Centralized identity management system and method for delegating resource management in a technology outsourcing environment,” 20060129817 for “Systems and methods for enabling trust in a federated collaboration,” 20060123476 for “System and method for warranting electronic mail using a hybrid public key encryption scheme,” 20060075461 for “Access authorization having a centralized policy,” 20060074863 for “Method, system, and apparatus for maintaining user privacy in a knowledge interchange system,” 20050246770 for “Establishing computing trust with a staging area,” and 20050223217 for “Authentication broker service;” which are incorporated by reference as if fully set forth herein.

### SUMMARY

One embodiment includes a system for creating an online identity credential based on verifying the identity of an individual subject. The system can include adding first, second, and third party information to the credential, analyzing the data in the credential to create metadata stored within the credential, continuously and periodically updating the elements and metadata of the identity credential, and for sharing selected data and metadata elements of the credential with second and third parties. The system can be used as a standalone identity credential or in support of biometric identity applications. The system optionally can include rewards to encourage the subject to continuously verify their identity. The system can include a Knowledge Based Authentication (“KBA” or “Quiz”) which is based on intention analysis derived from second-party data, rather than factual third-party data.

Third-party data sources can be created, maintained, and edited about the subject, by a third party unrelated to the subject. In some cases, third-party data is about the subject, but the third party may not be involved directly in a transaction with the subject. Third-party Data sources that may be queried, either directly or through intermediate aggregators, can include but are not limited to, for a few examples: Federal, State, County and other municipal records; financial records like bankruptcies, liens and judgments; property ownership records; government agencies, government-issued and other licenses; law enforcement records on felony and misdemeanor convictions; address history, credit history, employment history; knowledge-based authentication quizzes based on third-party data; identity history based on combinations of social security number, address, name, and on combinations of similar data elements; UCC (Uniform Commercial Code) records that reveal the availability of assets for attachment or seizure, and the financial relationship between an individual and other entities.

Examples of third-party data sources can include data aggregation services which support background checks or which provide authentication functions or trust services in e-commerce transactions. An example of a third-party data source is a data store operated by a service provider who acts as a trusted intermediary to facilitate transactions, such as computer-based transactions.

Second-party Data Sources can be created, maintained, and potentially edited about the subject, by a party involved directly in a transaction with the subject in which the subject has large or total control over the transaction. Although the subject may maintain their own similar or identical records of transactions, second-party data may come from a source other than the subject.

Second-party data may also include normalized reference data from many people that use the second party's services or products, for comparison. Second-party Data sources that may be queried, either directly or through intermediate aggregators, include but not limited to, for a few examples: cash, credit card, debit card, purchase history; reward and rebate utilization and preference history; online services history including email service providers, social networks, microblogging and reputational networks; utility services history; dynamic historical location data about the subject or their assets; dynamic financial data about the subject; dynamic and historical health data about the subject.

Utility services history can include, for example, last month's electric bill for the subject. An example of normalized data might include whether last month's electric bill was high or low for the subject's past 24 months, whether last month's bill was high or low compared with similar months in the past five years and corrected for the local weather, and/or whether last month's bill was high or low compared with all (or a substantial number of) utility customers while correcting for comparable neighborhoods and past history. This data can be further analyzed to provide intention data, digital insight into subject behavior. For instance, it could be that a subject decided to turn the thermostat down substantially this winter to save money. Or it could be that a subject has a new roommate or family member and is knowingly using much more heat. In either case, analysis of monthly utility data compared with normalized data can help provide a question which the subject can readily answer: Did you recently make a big change in your thermostat up, down, or not at all?

Dynamic historical location data about the subject or their assets can, for example, include a person's past travels from 1 year ago, 1 week ago, or 1 hour ago. It could be derived from cell phone tower data, smart phone GPS data, automobile GPS data, ISP access data, credit card and cash transaction data, or postings to social networks or even private emails.

Dynamic financial data about the subject can include, for example, date and time of ATM usage, or even stock asset sales could form the basis of questions such as “Your last ATM withdrawal was “a) 1 week ago at night, b) 3 days ago in the morning, c) 1 month ago, d) more than 1 month ago.”

Dynamic and historical health data about the subject. While such data is considered private, as long as the data complies with HIPAA and other government regulations, it would form data which frequently only the subject is aware. This could include diagnosis, doctor/hospital/clinic visits, over the counter and prescriptions filled, and treatments recommended or obtained.

In most cases, second-party data sources require the user's explicit permission to access summary, detail, or aggregate data relating to a user. By contrast, third-party data sources already have collected and aggregated data about a user, and can deliver it to multiple parties providing that they meet regulatory qualification, with or without the user's permission. In some cases, third-party data is historical in nature, allowing an aggregator, a relative, or an imposter time to access this information. By contrast, second-party data includes dynamic information that is private and not normally accessible to aggregators, imposters, or relatives closest to the subject. Third-party data is limited to a handful of data sources permissible by law, by contrast second-party data can include virtually all activities, personal data, and mental processes of the subject, so long as they have agreed to let this information be utilized to protect their identity.

First-party Data Sources can be created, maintained, and edited by the subject. Most commonly this includes biographical notations, and annotations on any second- or third-party data.

Review, Report, and Annotation: A user may desire to review data from the third-party and second-party sources to determine if the data is accurate, for example, a user concerned about possible identity theft or the possibility of being confused with a terrorist or criminal. Another type of user might be interested in the information from such sources because s/he is contemplating a transaction with the person and wants to verify information about the subject, for example, a background check on a prospective employee or confirmation of the authenticity in a transaction.

The present application discusses, inter alia, (1) augmenting and verifying the accuracy of such data, (2) to expose and/or correct discrepancies and or otherwise take steps to correct misinformation held in records relating to the subject, (3) selectively sharing subject data, and (4) continually verifying that the subject who access their online credential is the true subject. Such features can be used in various combinations to provide an identity credential that can facilitate transactions of many types, both online and offline, and may help to provide earlier notification of theft of the subject's identity or fraud involving the subject.

In the area of identity theft, subjects may need to manage and mitigate different kinds of risk, for example, the risk of corrupt, missing, or information erroneously attached to their identities which may be stored in the second-party and secondary types of sources. A subject's ability to check their information can provide not only the ability to avoid confusion by third parties, such as prospective employers, but also an indication of fraudulent use of personal information such as would attend an instance of identity theft. Armed with such information, subjects can takes steps to protect their identity from further exploitation, mitigate future risk, and/or repair damage done by identity theft. Also, the subject's ability to perform transactions which rely on these data can be protected.

As described below, a True Online Credential (TOC) may be generated, which may serve as a comprehensive report or body of data summarizing the information stored in first/second/third-party data sources and which may otherwise be available to others about the subject. Such a TOC can be generated by the subject for his or her own use, or to facilitate transactions with others. In embodiments, a system may sift through many, (e.g., 10 billion) records housed and administered by one or more data aggregators and culled by them from various public sources. In embodiments, a report is generated from these records using a networked architecture and delivered to a user (the subject of the search) via a terminal. In this example, the system can assemble this information into a single document (the TOC) which may be delivered online in an electronic format (such as an html or pdf type document) or printed and mailed to a user, for example. The TOC may also take the form of a shareable report, in which case an electronic identifier is sent directly and/or at the subject's request to another party. That identifier allows the subject to receive the report directly from the TOC system. Any interaction with the TOC about a particular subject by either the subject or another party can be stored, and can become part of that subject's TOC as second-party information.

Various means of authentication may be provided to prevent someone other than the particular subject of the research from generating that subject's TOC. One mechanism can use identification information about the user to query one or more data sources for further information. The system can then generate a quiz based on this information to verify the contents of this further information. For example, the quiz may ask the user to indicate which of a list of addresses was a former residence of the user. The question can be generated as a multiple choice question with “none of the above” being a choice, to make it more difficult. Other kinds of questions can be based on the identity of a mortgage company, criminal records, and/or any of the information the system accesses.

The standard KBAs that are in use in the industry and commercially available are all derived from third-party data. In one embodiment, the TOC relies upon several types of commercial KBAs to ascertain if the subject that is accessing or signing up for the TOC is indeed the correct subject. The TOC may pull from a number of commercially available KBAs including those based on credit records, those based on non-FCRA credit header data and other public records data (known as public records KBA), or a combination of these data types. A third type of third-party KBA using non-financial, non-public-records data can be included. These KBAs can be presented to the subject based on algorithms that contain deterministic and heuristic decision making. For an example of a deterministic decision, if the subject is a 50 year old who is referred to the TOC by way of a bank, then the credit-based KBA can be used first. However, if the subject is 35 years old and referred to the TOC by way of a payday lender, then the public-records based KBA can be used first. And if the subject is 25 years old, then the non-credit non-public-records KBA can be used first. An example of a heuristic decision is which KBA to choose if the subject fails the first KBA. Further elements in the decision making will include cost of KBA, predicted demographic coverage relative to the subject's demographics, accumulated TOC-systemwide success rates of each KBA type with regard to the subject's demographics, which KBA types the subject has been exposed to previously, as well as a random element.

Third-party KBAs, which are the industry standard, have several limitations. (1) They are costly. (2) They result in a high incidence of questions requiring too precise subject recall, resulting in higher failure rates and harder to answer questions. (3) Credit-based KBAs and most public-records KBAs have very limited or no coverage of the vast unbanked segment of the population, estimated to be as much as 20% of adults. Both limitations 2 and 3 can be partially overcome by using multiple KBA vendors, as one embodiment of TOC uses. (4) Third-party KBAs are based on data that is seldom more recent than 30 days, and more typically 60-90 days is the most recent data in a third-party KBA.

Intention KBA: In one embodiment, the TOC can utilize a KBA which is based on second-party data. This KBA has several novel aspects: (1) The data is cheaper than other third-party KBAs. (2) Some of the second-party data can be derived from interactions with TOC itself, rather than from outside vendors or aggregators of second-party data. (3) The second-party data can in some cases require explicit permission from the subject to acquire it. While an impediment to using some of this data for 100% of TOC subjects, it allows TOC to access data that is extremely personal, specific, and easy for the subject to know. For example, the TOC may request and gather the locations and names of Facebook friends commonly contacted by the subject, and use that as second-party data in a KBA. (4) Second-party data can be analyzed and provide intention, rather than just facts. One example is that setting of a thermostat, described above. Another example of intention data is when the TOC gathers from a second party the types of charities and amounts of donations that a subject has recently chosen, as distinguished from their usual pattern and from regional patterns. This data enables a highly specific, easy to answer KBA question to be formed which is unparalleled by commercial third-party KBAs.

Intention data derived from second-party data in the financial world is well known. For instance, if my usual credit card purchases are at convenience stores in greater New York City for under $20, and a credit card transaction appears which is in Los Angeles for jewelry for $800, the financial institute may immediately raise red flags, and either deny the transaction, freeze my credit card, and/or contact me by phone. However, all of these systems are designed to protect the financial institution and their assigns from fraud. None of these systems are designed to protect the consumer. In this particular case, if the consumer is indeed the victim of an identity thief attempting to buy jewelry, then the consumer is not responsible for the purchase. Further, none of these systems are designed to build a KBA out of second-party intention data, or even to expose the results of the analysis to the Subject.

Continuous, Grayscale: Existing verification systems take a one-time authentication, all-or-none approach. One embodiment of a TOC system utilizes a continuous authentication, grayscale approach. (1) All, or a substantial number of, data elements and analysis relating to identity can either raise or lower an identity score. (2) In one embodiment, the TOC may not only utilize a second-party KBA, but may do so on a frequent basis, including both coincident with a transaction and at times other than during an actual transaction. (3) In one embodiment, the TOC can utilize third-party KBAs repeatedly throughout the lifetime of the subject. (4) The TOC can incorporate an identity fraud system from a third-party data source which provides constant assessment of data which can raise or lower the identity score. (5) The identity score in this TOC can be a set of identity scores. For instance, an identity score might be 95% with regard to a small financial transaction, but only 70% with regard to a large financial transaction. (6) The TOC identity score can automatically degrade over time. The degradation rate can vary with different types of scores. For example, a small financial transaction identity score can degrade slower than a score designed for a high-security job clearance. Upon re-verification of a data point, the score(s) can increase.

Solves Large Biometrics Limitations: Although biometrics are commonly thought to be the best type of authentication possible, they have one spectacular failure point at the onset of their process: The actual verification that the person is who they say they are. If an imposter, during the issuance of a biometric authentication, claims that they are someone else, then the biometric system will mistakenly credential the imposter. This represents a potentially serious flaw in all biometrics applications.

Biometrics devices have a significant failure rate of 1-7% (http://www.authenticationworld.com/Authentication-Biometrics/index.html) and this is due to a variety of factors, from maternal twinning (6/1000 births) to long eyelashes to manual labor. Some inexpensive fingerprint systems have noted failure rates as high as 30% (http://www.zdnet.com.au/30-failure-rate-for-biometric-pokies-339309023.htm). Where biometrics fails, one or more of the embodiments discussed herein can serve as an alternate.

Much More Resistant to Imposters: The assumption of a part or whole of an identity by an imposter is a problem that ranges from inconvenient, in the case of credit card theft, to disastrous, in the case of terrorism. Because many non-TOC systems of verification rely on data that is months or years old, it allows the imposter to use multiple means of acquiring the identity data of the victim. And once that identity data is obtained, it may have a “shelf life” of months or years. By contrast, the TOC's continuous process can incorporate recent data into the authentication process, data which may be less than an hour old, and which may only be valid for a few hours or days.

In embodiments, the TOC is generated from a third-party source that collects information and makes it available without having to go to the many multiple third-party sources. In the embodiments, the system may generate a TOC which includes a form to accept data from a user indicating that certain data is questionable or indicates misinformation about the person or that some specific piece of data is missing. For example, a criminal conviction might appear on the TOC which could mistakenly be associated with the subject or a piece of real estate the subject formerly owned could be missing from the TOC.

In these embodiments, the user feedback indicating a question about the report contents may be used to generate a further query to second-party sources. Many problems can occur in the uptake of data from second-party sources to the third-party aggregators used to generate the reports. So a query of the second-party sources may indicate the source of the erroneous or missing data as being due to an error in the third-party data source. Since the second-party may be more authoritative, the correct second-party data may be delivered to the user in a second report which juxtaposes the second-party and third-party data. The second report may include the subject's own comments in juxtaposition, for example, explanations for certain events with citations to supporting data may be entered and included in the report. These “annotations” may play a role in performing transactions where the system may provide the annotations as qualifiers to other information used in the transaction.

In alternative embodiments, rather than querying second-party or third-party sources in response to a subject's indication of questionable data, the sources may be queried based on a schedule of sensitivity, degree of risk imposed by errors, and/or likelihood of errors. For example, if the first query of the third-party source turns up criminal records that are closely associated with the subject, for example based on an identical name, the third-party sources in the associated jurisdiction may be queried to provide verification or highlight a discrepancy in the data or confirm or refute the relationship between the data and the authentic subject.

Another alternative may be to limit the scope of search of third-party sources based on “bread crumbs” left by the subject throughout his life. For example, the second-party sources for each state the subject has lived in (as indicated by the query result of the third-party source) may automatically be queried, rather than just relying on the third-party sources. Yet another alternative is to offer the user, who would also be the subject, a form to ensure that the data obtained and used to query the second-party sources is complete. For example, the user may be shown a list of states in which the subject appears to have lived based on the first query of the third-party source and asked if the list of states is complete. The user may then enter additional states as needed and the second-party sources can be queried based on the complete list.

Yet another alternative may be to query both third-party and second-party sources. This may have value for a user if the third-party source is one that is routinely used by third parties. Discrepancies between the second-party and third-party sources can provide the user with information that may help him answer or anticipate problems arising from third party queries of the third-party source. For example, if the user applies for a job and the prospective employer obtains data from the third-party source, the user may be forewarmed with an answer to any questions arising about his background. For example, the user may note on his application that there is corrupt data in the third-party source regarding his criminal history. Note that the alternatives identified above may be used alone or in combination.

The second-party sources may be considered more authoritative since any data in the third-party sources may be the result of transcription errors, data corruption, or other process that distort data aggregated from the third-party sources. A subject concerned about misinformation being obtained and acted upon by an interested third party (such as one involved in a transaction with the subject) may be offered by the user to the third party in some form. For example, a certified report showing the report fleshed out with data from both the second-party and third-party sources according to the above may be generated by the system.

According to additional embodiments, the second report, with second-party as well as third-party data and also with user-entered annotations and citations, may be generated by the user and printed. Reports or other kinds of transaction data may also be generated by third parties using an online process. For example, the system may store the complete second report after querying the second-party sources and adding user annotations. The report can be generated by the user or by a third party with the user's permission and under the user's control, for example, by providing the third party with a temporary username and password provided on request to the user by the system and providable by the user to the third party. Alternatively, the data involved may be used in the mediation of a transaction with the subject. The credibility of the report stems from the fact that it cannot be altered directly by the user, the owner of the system deriving value from its integrity as well as the annotations and additional information provided by users.

Also, information for which there is a discrepancy between second-party and third-party data may be submitted by the system operator to operators of the third-party source or sources. This information may be used to alter the third-party source data thereby to remove the discrepancy. Annotations and further citations submitted by the user through the system may also be transmitted by the operator of the system to the operator of the third-party source(s) for purposes of correction.

A user may subscribe to a service offered by the system, for example by paying a one-time fee or a periodic fee, which allows the user to obtain and recompile information. In addition, according to a similar subscription model, the user may receive periodic, or event-driven change reports which indicate changes in the content of the user's TOC. The change report may be delivered as full report with changes highlighted or as just a report indicating changes that have occurred. During the period of the subscription, the system may compile and keep a record of changes so that an historical record may be created and accessed and reviewed by the user. For example, the user may obtain change reports between any two dates.

TOC or associated information can be provided to highlight data that are particularly sensitive or important and also to indicate the relevance of, or what to do about problems with, each item of the data in the TOC. The TOC may include, along with a detailed listing of findings, a narrative, automatically generated, which discusses the most salient features of the TOC. Such a narrative may be generated using template grammatical structures in a manner used by chatbots (chatterbots) for example, see U.S. Pat. No. 6,611,206, hereby incorporated by reference as if fully set forth in its entirety, herein. Also, preferably, TOCs will indicate what search criterion was used to retrieve the record. In querying databases, there is no one unique identifier of a person who is the subject of the search. The person's name, social security number, or other information may be used alone or in combination with other data. Also, close matches to the name may be used. A user reviewing his report may be interested to know how the record was associated with him and this may be indicated by the TOC overtly or conditionally, such as by a hyperlink button or mouse-over balloon text, for example.

Various objects, features, aspects and advantages of the present invention will become more apparent from the following detailed description of preferred embodiments of the invention, along with the accompanying drawings.

### BRIEF DESCRIPTION OF THE DRAWINGS

FIG. 1 illustrates a network or Internet architecture for implementing various features of the embodiments discussed herein.

FIG. 2 is an overview of User enrollment in TOC and initial Identity Verification Score computation.

FIG. 2A is a flowchart showing User enrollment in TOC and initial Identity Verification Score computation.

FIG. 3 illustrates no user, change in score, second-party data, and prepare scores.

FIG. 3A is a flowchart showing no user, change in score, second-party data, and prepare scores.

FIG. 4 illustrates internal KBA, intention data, and continuous verification.

FIG. 5 illustrates first-party Notes, Shareable data, and third-party non-verification data.

FIG. 6 illustrates sharing modes.

FIG. 7 compares various categories of data.

FIG. 8 gives examples of different data types.

FIG. 9A shows an example of government I-9 verification.

FIG. 9B shows an example of TOC in use as a government I-9, and efficiencies obtained.

FIG. 10 shows how the TOC solves a fundamental flaw in biometric systems.

FIG. 11A shows how second-party data can be utilized.

FIG. 11B shows how second-party data can be utilized even without leaving second-party's premises.

FIG. 12 shows various data and application layers for implementing various features of the embodiments discussed herein.

### DETAILED DESCRIPTION

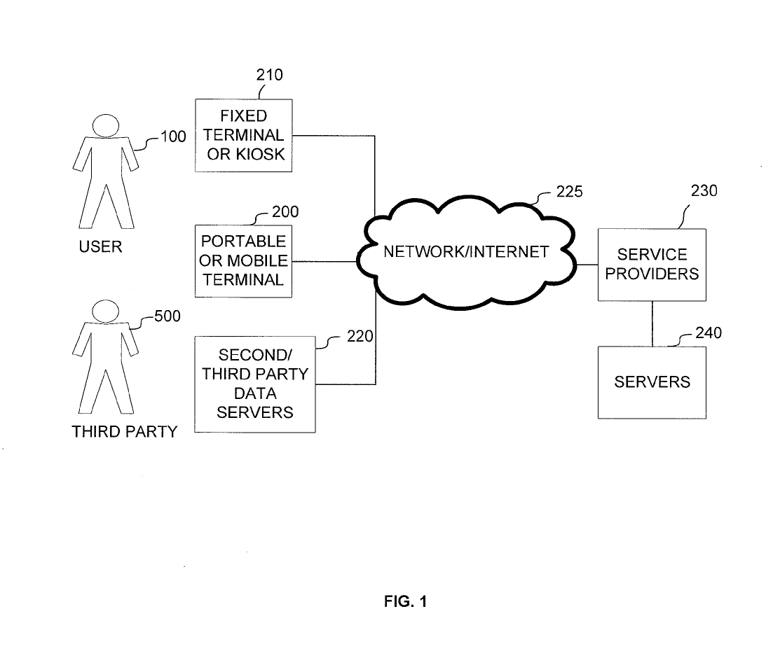

FIG. 1 illustrates a network or Internetwork architecture for implementing various features of embodiments discussed herein. The embodiments concern reports of information from content databases, for example public records of interest to the subjects of the reports, for example, individual consumers. Examples of public records include credit profile data, criminal convictions, financial records such as bankruptcy, and property ownership records. A user 100 may request information from one or more servers 240 through a wireless (portable or mobile terminal) 200, or fixed terminal (or kiosk) 210, via the internet 225 and a service provider 230.

The request may be entered in a form, for example an html form generated by a server 240 and transmitted to the terminal 200, 210 via a network, internetwork, and/or the Internet 225. Data submitted by the user 100 (or interested third party 500, assuming the subject of the data is said user) may be transmitted from the terminal 200, 210 via a network, internetwork, and/or the Internet 225 to the server 240 (which may be the same or a different server or servers) and used to generate a query. The query may be generated on one server 240 and transmitted, via network, internetwork, and/or the Internet 225, to another server 240 and in response data obtained as a result of the query and also transmitted, via a network, internetwork, and/or the Internet 225, to the user 100 or third party 500 at a corresponding terminal 200, 210 or some other location, for example a permanent or semi-permanent data store for future access (not shown separately but structurally the same as servers 240). The network, internetwork, and/or the Internet 225 may include further servers, routers, switches and other hardware according to known principles, engineering requirements, and designer choices.

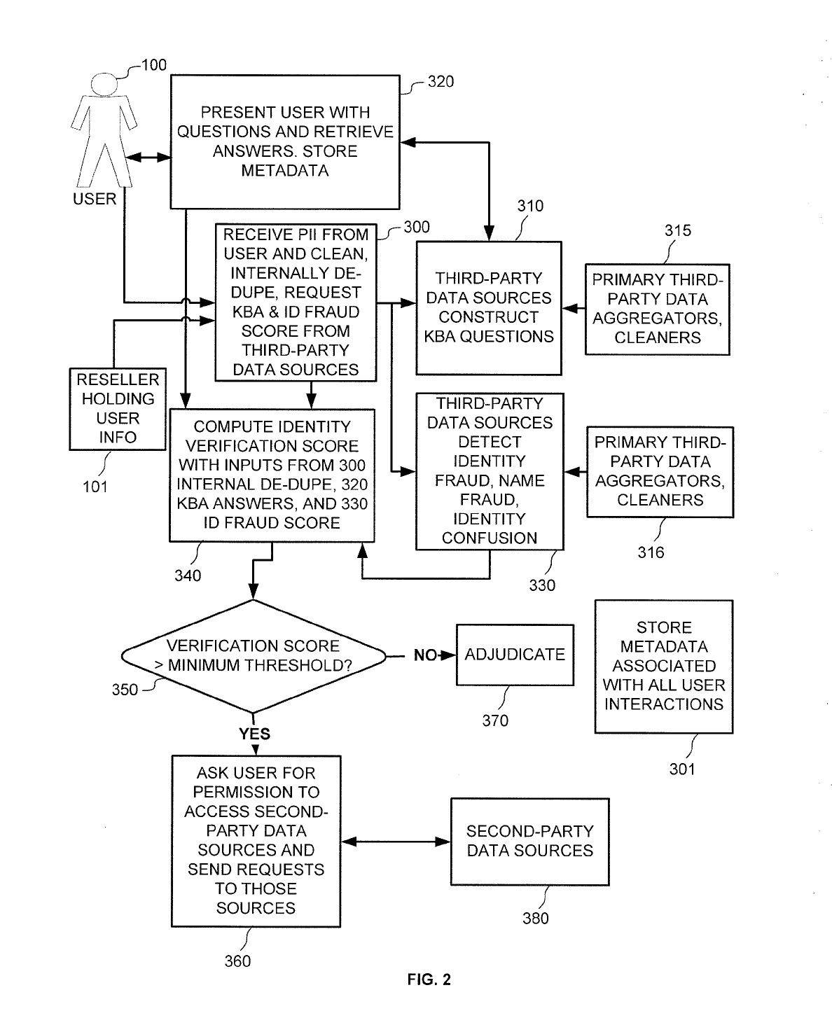

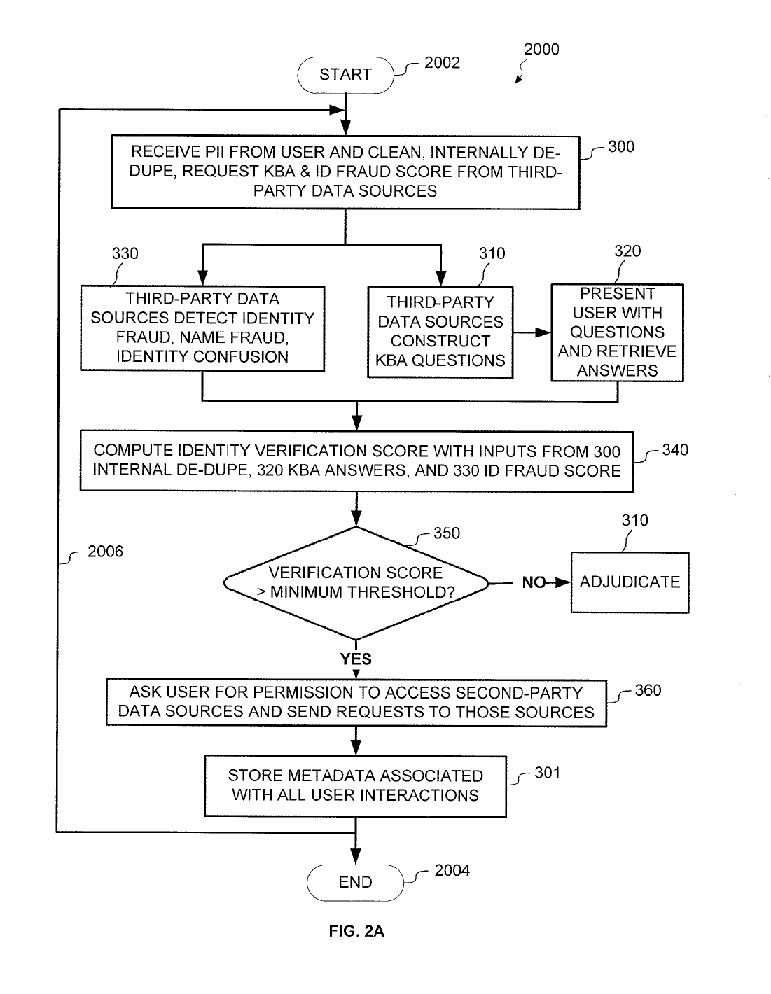

FIG. 2 an embodiment in which an initial user 100 enrollment, identity verification, and identity score is computed. The arrows illustrate data exchange processes which are described in the text. The entities represent computers, servers, and data transfers may occur through networks or internetworks, such as the Internet using any appropriate known protocols.

User 100 fills out a form with PII, Personally Identifiable Information such as full name, Social Security Number, Date of Birth, address, and phone number along with their requested TOC username and password. In some embodiments, this information may be supplied in whole or in part by an external Reseller 101 or fourth party who sends the information on behalf of the User and solely for their convenience. Further, the User 100 or Reseller 101 may enter biometric information in lieu of or in addition to the username and password.

Process 300 can receive the PII from the User 100 or Reseller 101 and do initial cleaning of data, and checking for duplicates against the internal User database to find conflicting elements. An internal dedupe score is calculated. Simultaneously, requests can be sent to third-party data sources 310, 330 using the User's PII.

Third-party data sources that specialize in Knowledge-based-authentication (“KBA”) “quizzes” 310 can receive the PII and construct the KBA. These data sources 310 can construct the KBA based on data that they acquire directly or through other primary data aggregators 315, and subsequently clean, de-dupe, append, and/or match to potential KBA requests. The central data request in a KBA can include a Social Security Number, name, address, and/or Date of Birth. The Third-party data provider can acquire data 315 in an asynchronous fashion prior to the actual KBA request, and the age of this data typically ranges from 20 years to 6 months, although the range is wider.

Although there are a number of commercial KBA providers 310, and a number of primary data aggregators 315, there tends to be significant overlap between the KBAs generated, regardless of KBA vendor 310, because there are only a finite number of facts that are in the User's universe using these commercial methods.

Process 320 can receive the KBA from 310 and format the KBA questions and present them to the User 100, and then receives the answers from the User. The number of correct answers along with metadata such as speed of answer can be stored by 320 and used in 340 to compute a KBA Answer score.

Third-party data sources that specialize in identity fraud, name fraud, and identity confusion 330 receive the PII from 300 either in serial or parallel with 310. These third-party data sources can receive information asynchronously from primary data aggregators and cleaners 316, who may have some or considerable overlap with other data providers 315 used by 310. An ID Fraud score can be computed, and the score and any relevant details can be sent back to 340, which then can compute its own ID fraud score.

After 340 has received the internal identity scores from 300, the KBA scores from 320 and the ID fraud scores from 340, it can create a basic calculation of Verification Score. A determination can be made at 350, and if the Verification Score is below a minimal threshold, then a human-assisted adjudication process can begin at 370. If the Verification Score is at or above a minimal threshold as determined at 350, then the user can be prompted 360 for permission to access additional second-party data sources. If permission is granted, then the second-party data sources 380 can be contacted asynchronously and their response stored. Further, in some embodiments, the threshold for successful verification determined at 350 can vary with the intended use of the verification credential by either the User 100 or the Reseller 101.

Throughout the processes shown in FIG. 2, Process 301 stores the metadata associated with the User interaction, including but not limited to such items as their IP and MAC address, the geolocation of their IP, the network speed, and the speed with which they fill out the forms.

FIG. 2A is a flowchart showing User enrollment in TOC and initial Identity Verification Score computation. Processing begins at 2002 and continues to 300.

At 300, processing is performed as described in FIGS. 2, 3, and 4. Processing continues to 330 and/or 310 as described in FIGS. 2, 3, and 4.

At 330, processing is performed as described in FIGS. 2, 3, and 4. Processing continues to 340.

At 310, processing is performed as described in FIGS. 2, 3, and 4. Processing continues to 320.

At 320, processing is performed as described in FIGS. 2, 3, and 4. Processing continues to 340.

At 340, processing is performed as described in FIGS. 2, 3, and 4. Processing continues to 350.

At 350, processing is performed as described in FIGS. 2, 3, and 4. Processing continues to 310 and/or 360 as described in FIGS. 2, 3, and 4.

At 360, processing is performed as described in FIGS. 2, 3, and 4. Processing continues to 301.

At 301, processing is performed as described in FIGS. 2, 3, and 4. Processing continues to 2004, where processing ends.

It will be appreciated that operations 300, 330, 310, 320, 340, 350, 310, 360, and 301 may be repeated in whole or in part (an example of which is indicated by line 2006) to maintain current (regularly or continuously updated) identity verification.

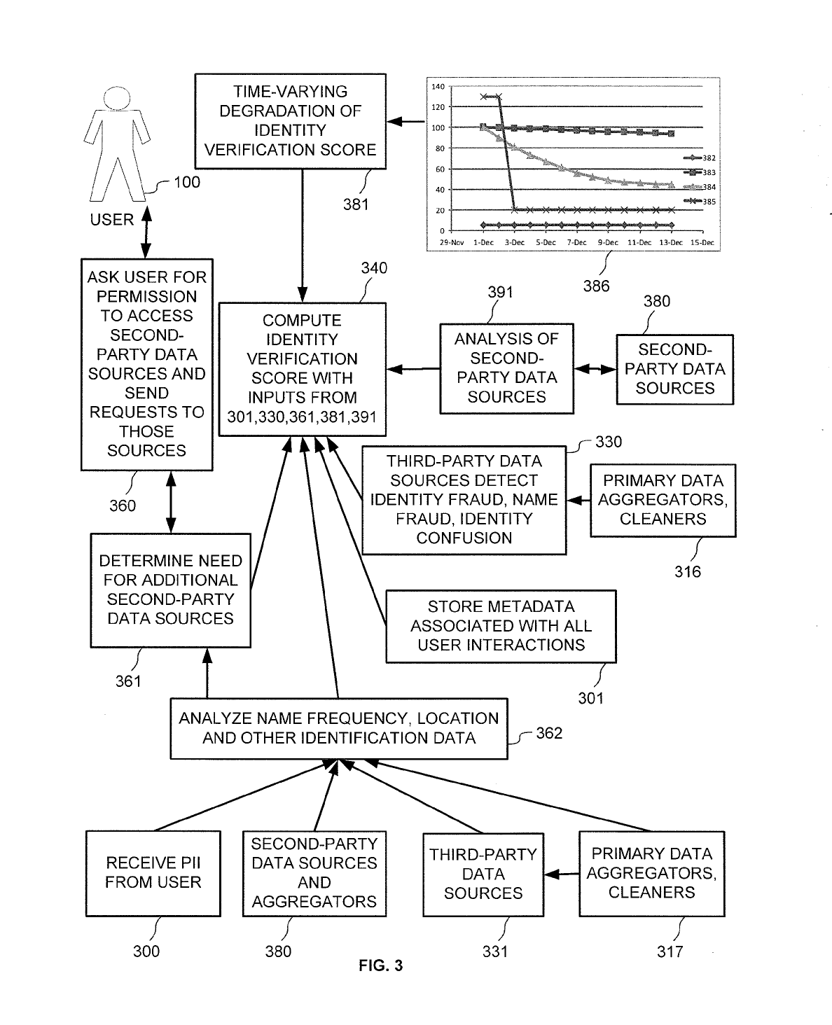

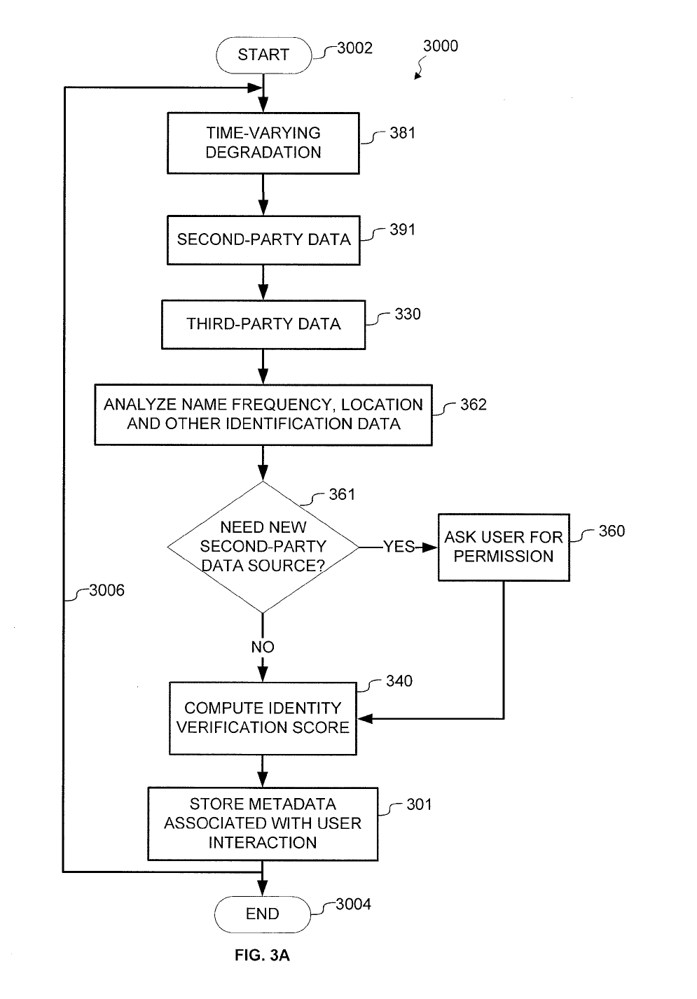

FIG. 3 an embodiment in which the Identity Verification score computed at 340 is continuously adjusted even though the User 100 may not have requested any action from the TOC. Different activities can affect the Identity Verification score at any moment after its initial computation independent of additional KBA or other verification activity from the User. In some cases, these activities will have a degrading effect upon the score.

In some embodiments, time itself can have a degrading effect on the score and this degradation can be calculated at 381. Four exemplars of time degradation shown in graph 386 can include: zero degradation 382 which could apply to scores which are so low that further data is not gathered; 383 slow linear degradation which could apply to scores with low security risk, such as verification for an online social network; 384 rapid exponential degradation which could apply to scores with high risk such as cashing a check for a large sum of money; 385 step degradation which could apply to a score that is given a temporary positive life based on manual adjudication, but which is limited to a time span of a few hours or days. Graph 386 shows the score on the Y axis and time on the X axis.

Second-party data 380 is continuously requested, received, and analyzed at 391. One use of this analyzed second-party data can be to look for clues that a User 100's identity has been compromised to a potential imposter. For example, if the User's social network includes new posts about being an identity theft victim or losing their wallet, this could lower the Identity Verification Score 340.

Process 362 can request, receive, and analyze data from multiple data sources and aggregators to ascertain time-stamped information about User's identity, imposter's use of User's identity, and/or other data related to a User's identity verification. Sources of this data can include the aggregated information from all Users 300; Second-party data sources and aggregators 380; Third-party Data sources 331, and Primary (or first-party) data sources and aggregators 317 which may partially overlap with 315, 316. The analyzed data from 362 can directly impact the Identity Verification Score 340. For instance, if process 362 determines through multiple inputs 300,331, 317 that a User 100's name is extremely uncommon and unique in the United States, and subsequently learns from 380 that there is a new person from a different geographical region who is claiming to have the same name, age, and interests, then 362 may cause score 340 to degrade. Another use of process 362's data is in process 361.

System 361 can keep track of which second-party data the User 100 has given permission to access, which second-party data is available with potential or likely User activity, and the delta between these two data sets. System 361 can request from the User 100 additional permission to access these missing second-party data sources at 360. The user's negative response to such requests at 360 can lower the Identity Verification Score 340. For instance, if User 100 lives in a single family house and denies permission for access to second-party data from the utility company 360, it may lower their score.

If the User 100 denies permission to access or the existence of particular Second-party Data, process 361 can notify 391 to preemptively monitor such 380 data sources for publically accessible data. For instance, if User 100's name, city and state match a Twitter account that is identified by 380, 361's propensity to request permission to second-party data representing User 100 on Twitter could increase proportionate to the activity on Twitter detected by 380. Additionally, 361's propensity to request 391 to proactively monitor Twitter data could increase.

Data from process 362 can also have an inhibitory effect on 361. For example, if it cannot be determined that a unique Twitter account can be identified that matches User 100, then 361 is less likely to request access to Twitter from User 100.

Third-party data that detects identity fraud 330 is received on a constant basis from its primary data sources 316. In the event of a match with a User 100, data from 330 can be passed to 340 for reduction in the Verification Identity Score.

As a User 100 interacts with the TOC, their metadata 301 can form the basis for degrading a score 340. For instance, if User 100 begins to access the TOC from China with multiple wrong password attempts, their score 340 could decrease.

FIG. 3A is a flowchart showing no user, change in score, second-party data, and prepare scores. Processing begins at 3002 and continues to 381.

At 381, processing is performed as described in FIGS. 2, 3, and 4. Processing continues to 391.

At 391, processing is performed as described in FIGS. 2, 3, and 4. Processing continues to 330.

At 330, processing is performed as described in FIGS. 2, 3, and 4. Processing continues to 362.

At 362, processing is performed as described in FIGS. 2, 3, and 4. Processing continues to 361.

At 361, processing is performed as described in FIGS. 2, 3, and 4. Processing continues to 340 and/or 360 as described in FIGS. 2, 3, and 4.

At 360, processing is performed as described in FIGS. 2, 3, and 4. Processing continues to 340.

At 340, processing is performed as described in FIGS. 2, 3, and 4. Processing continues to 301.

At 301, processing is performed as described in FIGS. 2, 3, and 4. Processing continues to 3004, where processing ends.

It will be appreciated that operations 381, 391, 330, 362, 361, 360, 340, and 301 may be repeated in whole or in part (an example of which is indicated by line 2006) to maintain current (regularly or continuously updated) identity verification.

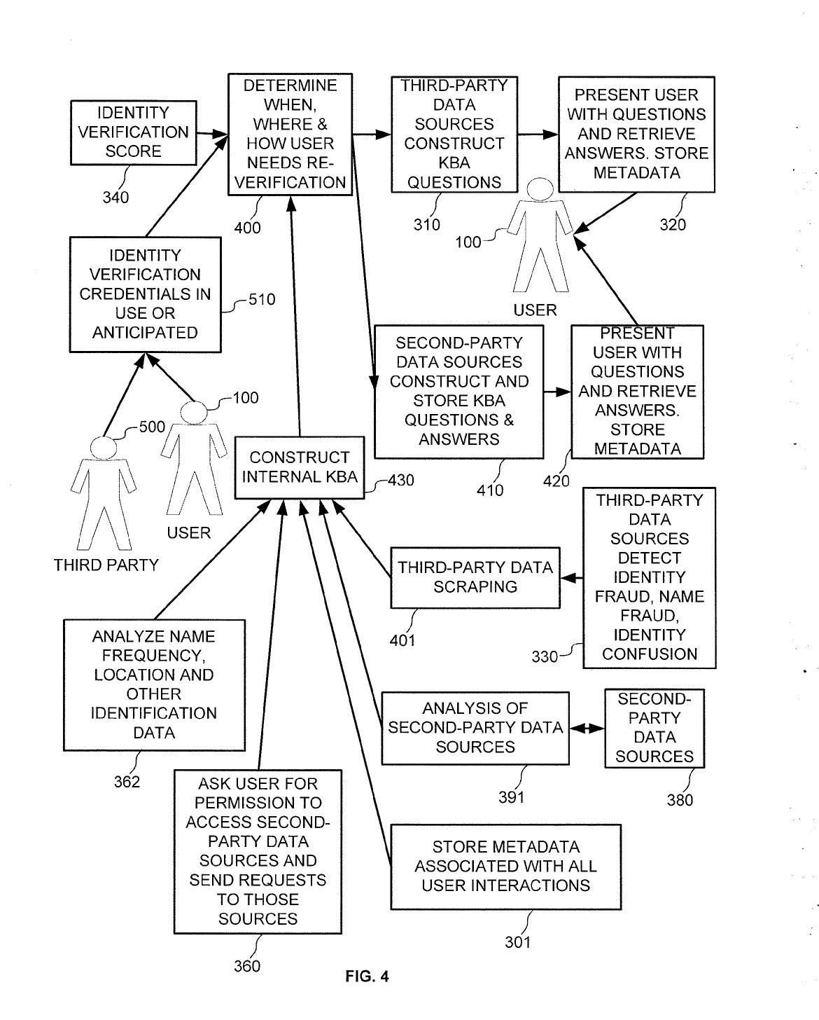

FIG. 4 is an embodiment of the TOC showing how an internal KBA is created and utilized, including continuous verification and intention-based KBAs. While the TOC relies to a large extent on third-party KBAs 310 during the initial verification procedure, these KBAs have many limitations, including: high cost that may exceed 100 times higher than internal KBAs; reliance on old data; reliance on factual data that can be more easily compromised by an imposter; reliance on data that can be difficult for the true User 100 to recall; limited availability of data for anyone with a “thin credit file” such as the under-25 population or the “unbanked” which is estimated to be more than 10% of the population; and legal and contractual limitations on how the data can be utilized or even presented to the User. One embodiment of the TOC includes one or more internal KBAs, which are defined as a combination of 1 or more questions that the user can generally answer with high specificity, while an imposter generally cannot. The internal KBA includes both factual data about the User as well as intention data that asks questions relating to the User's mood and other intentions that are not readily ascertained by imposters.

Process 400 can determine when, where, and how to request additional verification of User 100. If process 400 decides it is time for additional verification, then it can choose external third-party KBAs 310 and/or internal KBAs 410. External KBAs can have more limitations on their use and presentation 320 than the presentation of internal KBAs 420. If External KBAs are chosen, then there can be multiple third-party KBAs to choose from. In some commercial systems, only one third-party KBA and no internal KBAs are available. In one embodiment of the POC, three third-party KBAs are available, and other embodiments could include 50-100 internal KBA questions.

One input to Process 400 that influences the decision to request a new KBA includes the Identity Verification Score 340, with a multitude of factors including time that degrade the score. Another input to process 400 is process 510, which weighs the types of Identity Verification Credentials in current use, in past use, or in anticipated use. For instance, User 100 may indicate in their User Account that they anticipate the need for a highly specific verification credential able to be used for a high-security job. This factor would be used in Process 510 to indicate to 400 that there is a need for a high-security TOC, which would then trigger more frequent and tougher KBA requests. Similarly, third parties 500 can request a TOC on a particular User 100. While the User 100 can agree to share such a TOC, the third party can specify the degree of verification needed as an input to 510. Process 400 queries 510 frequently to determine if additional KBAs are needed to maintain the level of verification needed. An additional factor in this decision is the actual Identity Verification Score 340. Process 400 can determine that there may be a need to prophylactically request a KBA, if there is evidence from 510 of past high-security TOCs or other factors that lead 400 to believe that such a need is imminent. Such factors could also include the rate of decline of the Identity Verification Score 340 with a time estimate of when that score will no longer pass the threshold for successful identity verification. This look-ahead is part of the continuous verification process.

The process of constructing an internal KBA is handled by process 430. In general terms, KBA questions take the form of a fact, a question based on that fact, and then multiple alternate answers to the question that an imposter is just as likely to choose as the real answer. An example of a fact is that you have recently become friends with Kathy Jones in Cleveland, Ohio on Facebook 380 as discovered by 391; the KBA constructed in 430 might appear “Which of these people have recently become your Facebook friend? A) Cathy Jones in NY, N.Y.; B) Wendy Jones in LA, CA; C) Kathy Jones in Cleveland, Ohio; D) Wendy Jones in Columbus, Ohio; E) Kathy Jones in Miami, Fla.” This KBA question could be constructed if the User has previously given permission to the TOC to monitor the second-party data in their Facebook account 360, and in some cases it could be constructed by the TOC even without explicit User 100 permission by continuously mining Facebook data.

The internal KBA 430 includes data input from the name frequency and identity data 362; from whether or not the user has given permission to certain second-party data sources 360; from metadata associated with User interactions 301; from data scraping 401 of third-party KBAs 330; in addition to the most likely source of internal KBA data, analysis 391 of second-party data 380.

Internal KBAs give the TOC the option to present only one or two questions to the User, which can make the User resistance to answering much lower. Further, questions can be sent by email or text message, and it can be ascertained whether the User has logged in to their TOC to check the answer. An example of this is asking the User 100 by text message whether or not they have given permission to a local Utility to access their second-party data 360. In this example, the User would likely know the right answer quickly, and without needing to log in to their TOC User Account to check. If they do log in to their Account to check, then their answer, even if correct, serves to lower their identity verification score rather than to raise it.

The internal KBA 430 can be constructed on inferred behavioral data. Example 1: The User's Twitter feed or Facebook posts can be monitored for behavioral clues that are generally classified as happy, sad, etc. While this type of internal KBA is less specific than factually based KBA questions, intention-based KBA questions can be based on effervescent data so that a series of these questions can comprise a highly accurate identity verification source. Example 2: Second-party data 391 may include cash purchases or even the use of rebates for purchases. These purchases can be categorized into various categories such as food, entertainment, etc. It would be possible to ask Users questions such as “In the past week, your spending has gone A) Up, B) Down, C) about the same as usual.”

The internal KBA 430 can include data that is normally considered private. Because the internal KBAs are graded without giving the User feedback about right or wrong, and because there are continuous identity verification assessments, it may be difficult for an imposter or identity thief to glean the correct answer from a series of multiple choice quizzes. Further, because the correct answer to internal KBAs derived from second-party data is constantly changing, even a “cracked” question today does not do the imposter any good tomorrow. Examples of such a question might be: “In the past week, places you have been near to include a) Denver b) Broomfield c) Costco d) Aurora,” and “In the past week, you: a) watched the Wizard of Oz on Netflix, b) shopped at Kroger, c) took several pictures on your cell phone, d) made some new Facebook friends.” Assuming that the User gave appropriate permission for collection and use of second-party data, some highly personal questions could include “a) You tend to drive faster than the speed limit b) you drove more in the past few days than usual c) you purchased gasoline yesterday d) it took you 15 minutes to find a parking spot at Costco” and “a) Your doctor recently changed your asthma medication b) you paid your last utility bill late c) you check your online brokerage account almost daily d) you seldom purchase goods online unless you get free shipping.”

Even though the User 100 may be able to answer KBA questions 430, the volume of questions that the system can generate can be quite large, particularly if second-party data is available, 410 and 420. One of the benefits of this TOC is the ability to present User 100 with a stream of verification questions, potentially several questions per week. In contrast, a typical third-party KBA-based system will ask 5 questions once a year. However, the User 100 may need encouragement to answer this volume of KBA questions. Therefore, the TOC may offer as part of 420 a system of Rewards. The Rewards can be in the form of cash rebates, discounts, points, or other incentives for the User 100. By offering a number of reward types, the User's choice of rewards becomes yet another source of second-party data.

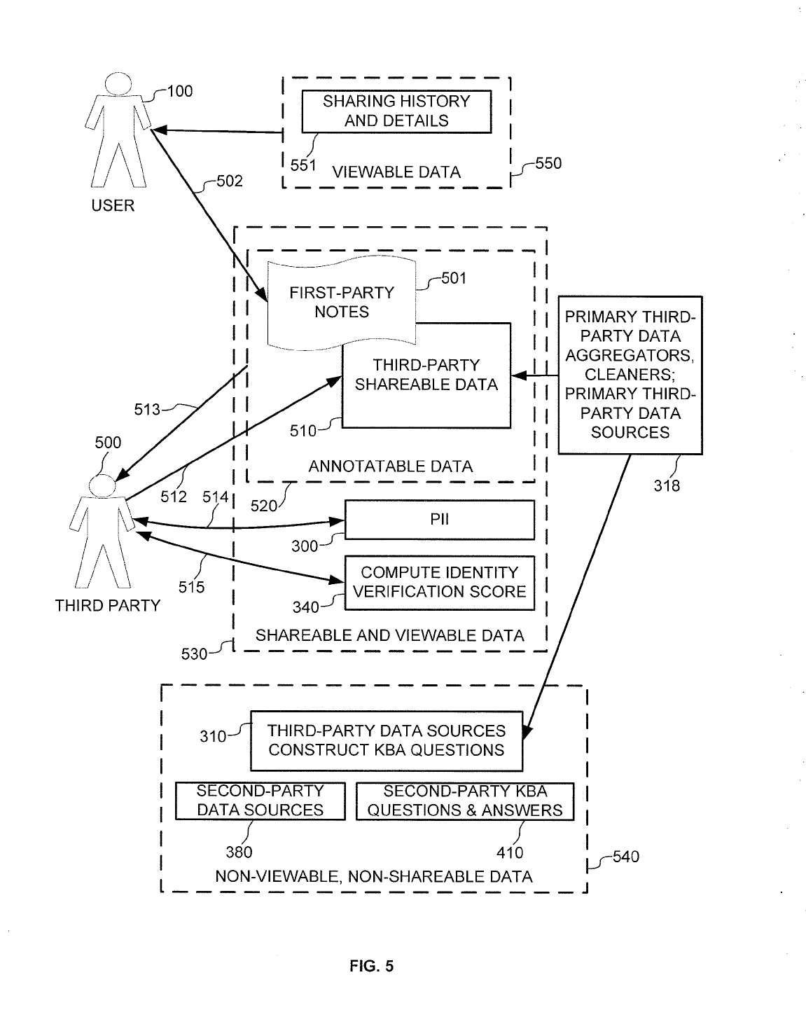

FIG. 5 illustrates first-party Notes, Shareable data, and third-party non-verification data. In order to provide any utility to the User 100, portions of the TOC must be shareable with one or more Third Parties 500. Generally, third-party KBAs 310, second-party KBAs 410 and second-party data of all kinds 380 are in the non-viewable, non-shareable group 540: they are not viewable by the User, not shareable by the User, and not viewable by a third party.

Shareable data 530 can include Third-party Shareable data 510, PII entered by the User 300, and/or the Identity Verification Scores 340. Shareable data can be viewed by the User 100. Third-party shareable data 510 can originate with Third-party data sources 318 which may overlap with 316 or 317 Third-party aggregators, cleaners, and primary data sources. Third-party shareable data 510 can be annotated 502 by User 100 by attaching a sticky-note 501 onto it. Third-party data which is in the annotatable class 520 is a subset of the 530 shareable and viewable data. If a third party 500 requests 512 to view or receive third-party data which has a Note 501 attached to it, the third party can receive 513 the User 100's annotation 501 as a supplement, appropriately marked as user-entered. By contrast, when a third party 500 requests PII 300 and/or an identity verification score 340, they can receive that data without annotations, 514 and 515 respectively.

An example of this is a criminal records report. The User 100 may request that the TOC search national databases for potential User criminal records 318. These records are annotatable, 520. If a third party 500 were to be given permission to view these records by User 100, they would receive the unaltered records 510. If at a later date the User 100 views and annotates the report 502, and subsequently a third party 500 requests 512 to view a background criminal report from the TOC, then the third party 500 receives both the unaltered criminal record report 510 as it was obtained from the aggregator 318, and also the User's notes 501.

Shareable data always requires the User 100's permission, explicit or implicit, in order to be shared with any Third Party 500. All sharing history and details are stored in database 551, and are a type of data that is viewable but not shareable 550. The sharing history allows User 100 to know as much as possible about who has viewed components of their TOC, and greatly increases the User's control over their own identity.

Examples of First-party Notes 501 include:
Annotations on third-party data
Biography, Resume
Qualifications (self-assessed)
Photo (self-contributed)

Examples of second-party data sources 380 include:
Health and medical records
Vehicle records, location, usage
ISP and email usage, records, and transactional data
Cash & credit purchases
Charitable giving preferences
Rebate & reward preferences
Medical and health records
GPS data from smartphone
GPS data from auto
Automobile vehicle driving data
Location data from cell phone towers
ISP data & meta data
Rental services, e.g. Netflix movie rental services and meta data
Social network data
Email data
Email and Social network meta data
Utility data (eg electric co)
Examples of third-party shareable data sources 316, 317, 318 include:
Medical and health data
Photo (third-party contributed)
Financial and credit data as provided by the three major credit bureaus.
Census data
Voting records
Telephone disconnects and other telephone company data
United States Postal Service address change request
Email databases
Fraud Databases, such as maintained by data aggregators that associate identifiers, such as a particular physical address, with known risk of fraud.
Telemarketing and Direct Mail Marketing databases.
Retailer databases including customer loyalty databases, demographic databases, personal and group purchasing information, etc.
Property ownership records, real estate records, asset ownership records, gun registration records.
Government-issued and other organization and professional licenses and registrations and professional and educational certifications, degrees, etc.
Law enforcement records on felony and misdemeanor convictions. Criminal records and special offender (e.g. sex-offender) registered lists. These include criminal convictions—including misdemeanors and felonies
Financial records like bankruptcy, liens, and judgments: These include bankruptcies, liens, and judgments awarded against an individual or individuals.
PACER: Public Access to Court Electronic Records (PACER) is an electronic service that gives case information from Federal Appellate, Federal District and Federal Bankruptcy courts.
UCC (Uniform Commercial Code) records that reveal the availability of assets for attachment or seizure, and the financial relationship between an individual and other entities. These include public notices filed by a person's creditors to determine the assets available for liens or seizure.
Secretary of State: including corporate filings identified by the names of agents/officers. An example of a web site offering such information is NY's department of state web site located at: http://www.dos.state.ny.us/
Internet search: matches from databases that may match or cite your name or names similar to yours, from Web search engines, usenet newsgroups, or any other Internet-accessible resource.
Personal Details: matches from databases that are associated with your name or names similar to yours, your past or present address and telephone, your SSN, your relatives, or even people that you have been associated with.
Insurance claims databases, such as CLUE, which store information about insurance claims made by individuals and organizations.
Warranty registration databases.
Credit Header Data: the addresses associated with your Social Security Number and name in credit reports. The address history in your TOC can be 10-20 years old.
HUD: Department of Housing and Urban Development (HUD) or Federal Housing Administration (FHA) insured mortgage, subject may be eligible for a refund of part of your insurance premium or a share of any excess earnings from the FHA's Mutual Mortgage Insurance Fund. HUD searches for unpaid refunds by name.
PBGC: Pension Benefit Guaranty Corporation, collects insurance premiums from employers that sponsor insured pension plans, earns money from investments and receives funds from pension plans it takes over.
Credit record
Employment information, attendance records, awards, certifications, salary and bonus history, pay grade, safety or other violations, union membership, recommendations, hiring and firing notices;
Education history.
Asset and property ownership data.
Fraud and ID theft info from financial networks
Address history
Relatives' names
Phone number history
Utility address change

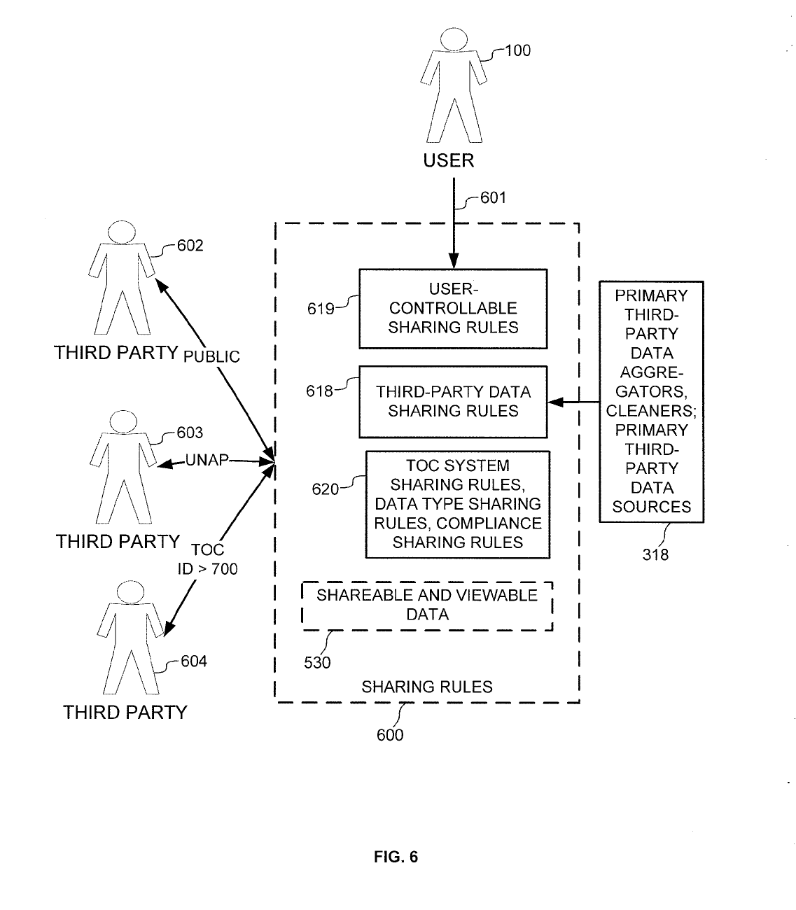

FIG. 6 illustrates sharing modes. There are three types of third parties that may make requests to see shareable data 530. Requests to see shareable data of all kinds are arbitrated by the Sharing Rules system 600, which can grant or deny such requests.

The general public 602 does not require any special provision to see shareable data. For instance, User 100 may place a link in their Twitter, LinkedIn, Facebook, or Google profiles which encourages the general public to click to view (request) their basic TOC profile containing name, city, state, age, and educational summary. If the User 100 had agreed 601 to allow such data to be viewed by public Third Parties previously, then that rule would be stored as part of the User controllable sharing rules 619 and such a request would be automatically granted and the appropriate 530 data released.

User 100 may determine 601 that some data, for example their criminal background check report, requires a User Name And Password (UNAP). When Third Party 603 requests an identity credential on the User 100, they are also given the criminal background check information if they can provide a correct UNAP. The User 100 may make their sharing rules in 619 time-dependent. For example, access to the User's background check information may be set to require a third-party UNAP for 2 days, and thereafter to expire and block requests. If a third party requests TOC access subsequently, the User 100 is informed by the TOC, and can make, if they so desire, a one-time or permanent change to the rules.

User 100 may want certain data to be more strictly controlled. For example, the User's credit score may need to be shared but on a much more restricted basis. In this case, User 100 can establish a rule 601 which is stored in 619, which can require that only specific third parties 604 can view the credit score, and further that third party 604 must have their own TOC with an identity score of >700. The User 100 may further restrict access to sensitive data by setting up a rule that requires that the third party 604 to have a biometric UNAP and to undergo a repeat verification of their identity verification score within the 5 minutes immediately preceding the third party viewing the sensitive data.

Some third-party data 318 may be subject to its own sharing rules which can be stored in 618. For example, the User's health record (EMR or EHR) may release certain information to the User 100 but restrict that information to the User and their family, and not to the general public. In this case, the rule is attached to the data by 618, and the user can set the sharing permissions to a more restrictive case but not to a less restrictive instance. The data could also be subject to HIPPA rules contained in 620.

The TOC system itself has rules 620, and may include rules to protect the TOC, rules required by blanket agreements with data vendors, and/or rules required for the TOC to ensure compliance with applicable laws. These rules 620 like the 618 rules, can be set to be more restrictive but not less restrictive by the User 100.

The general hierarchy of sharing rules is that TOC system rules 620 have restrictions which cannot be lowered; third-party data sharing rules 618 if applicable can further restrict sharing; User-controllable sharing rules 619 can further restrict sharing.

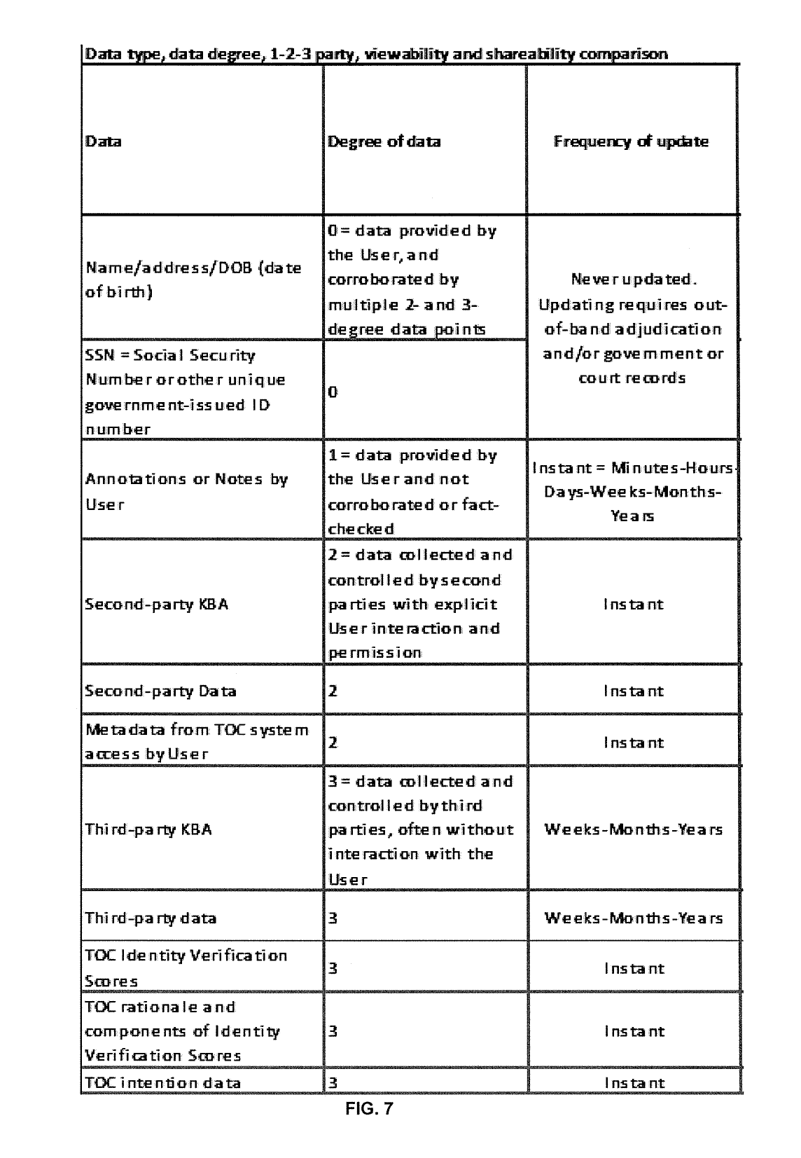

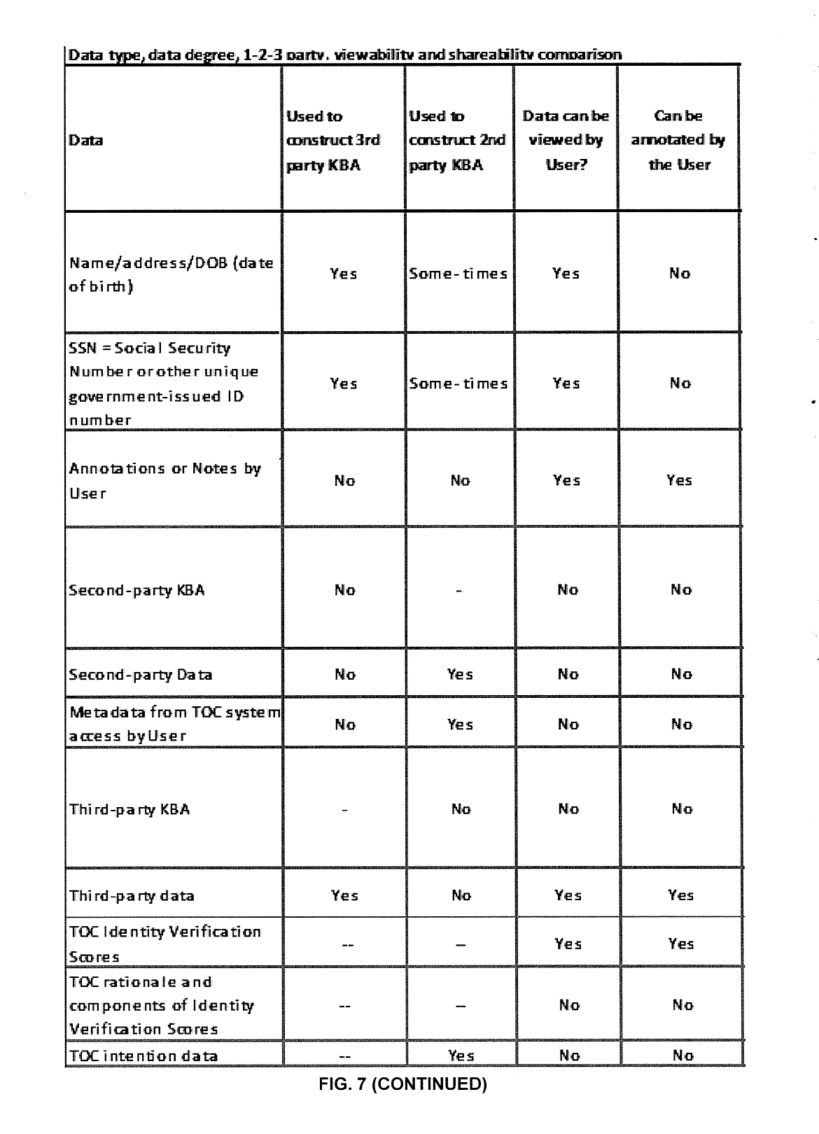

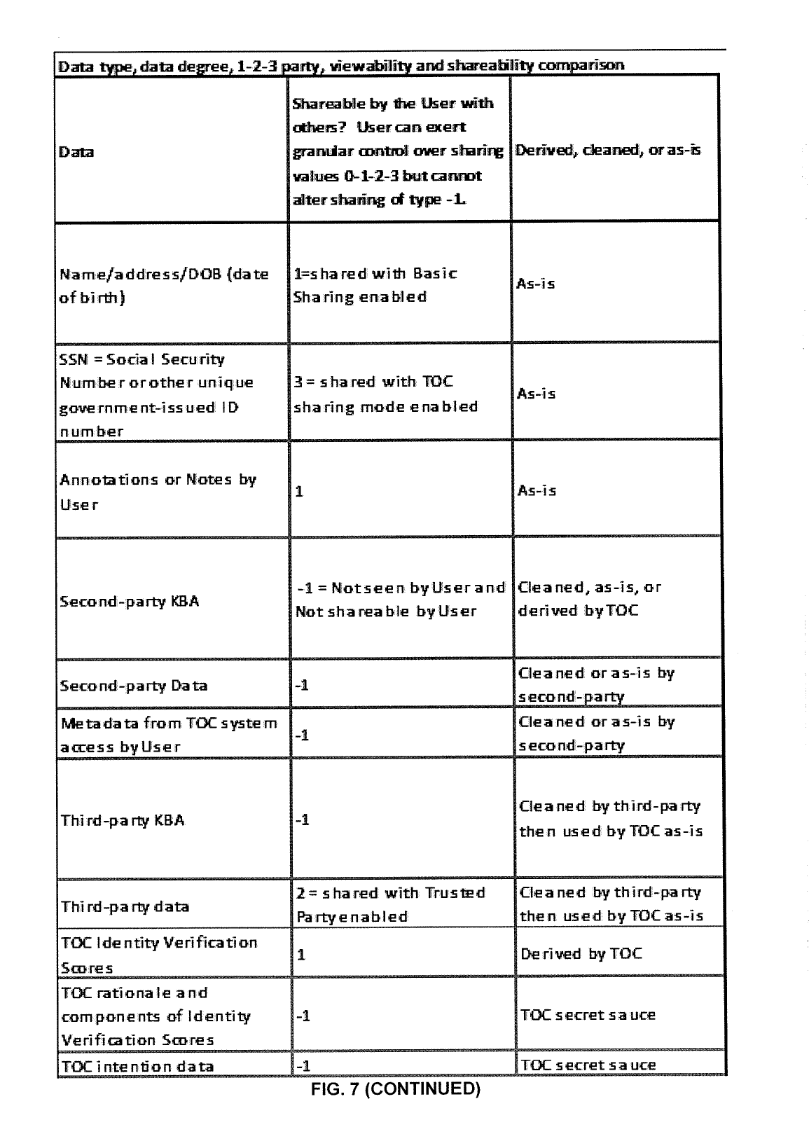

FIG. 7 compares various categories of data, whether they are first-party, second-party, or third-party data, whether they are used to construct KBAs, whether they are viewable or shareable by the User, and other characteristics.

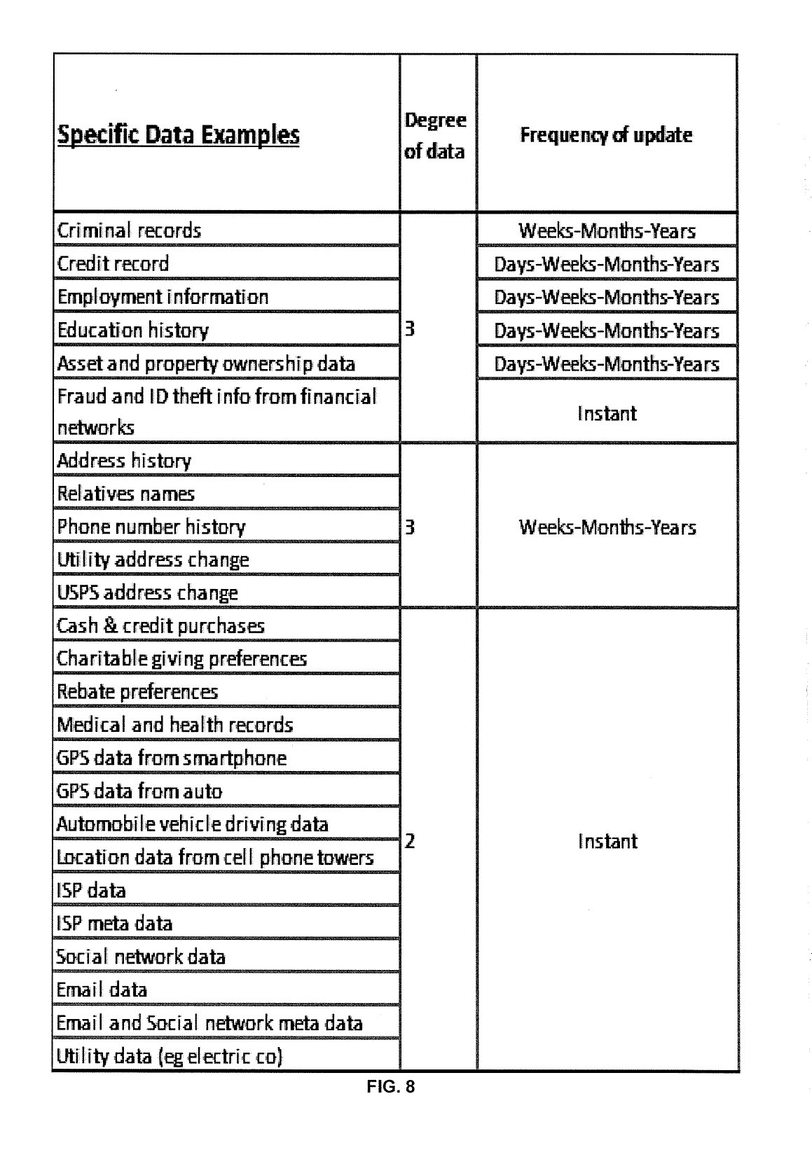

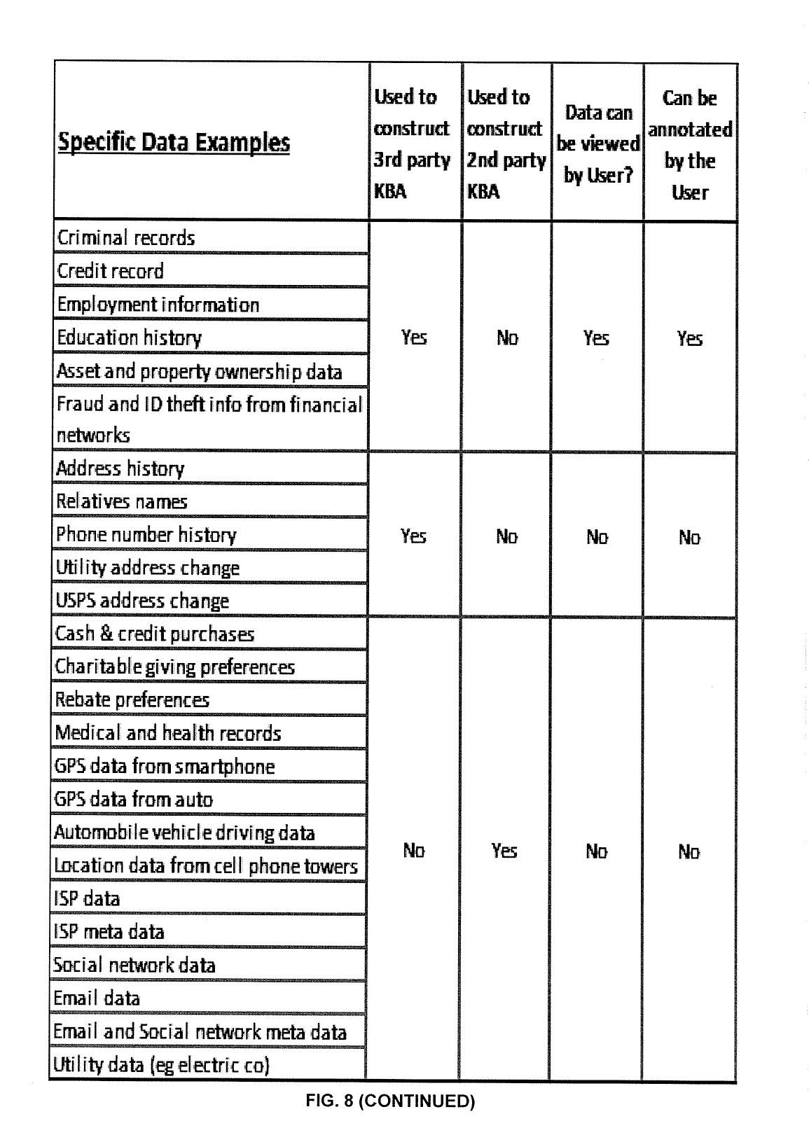

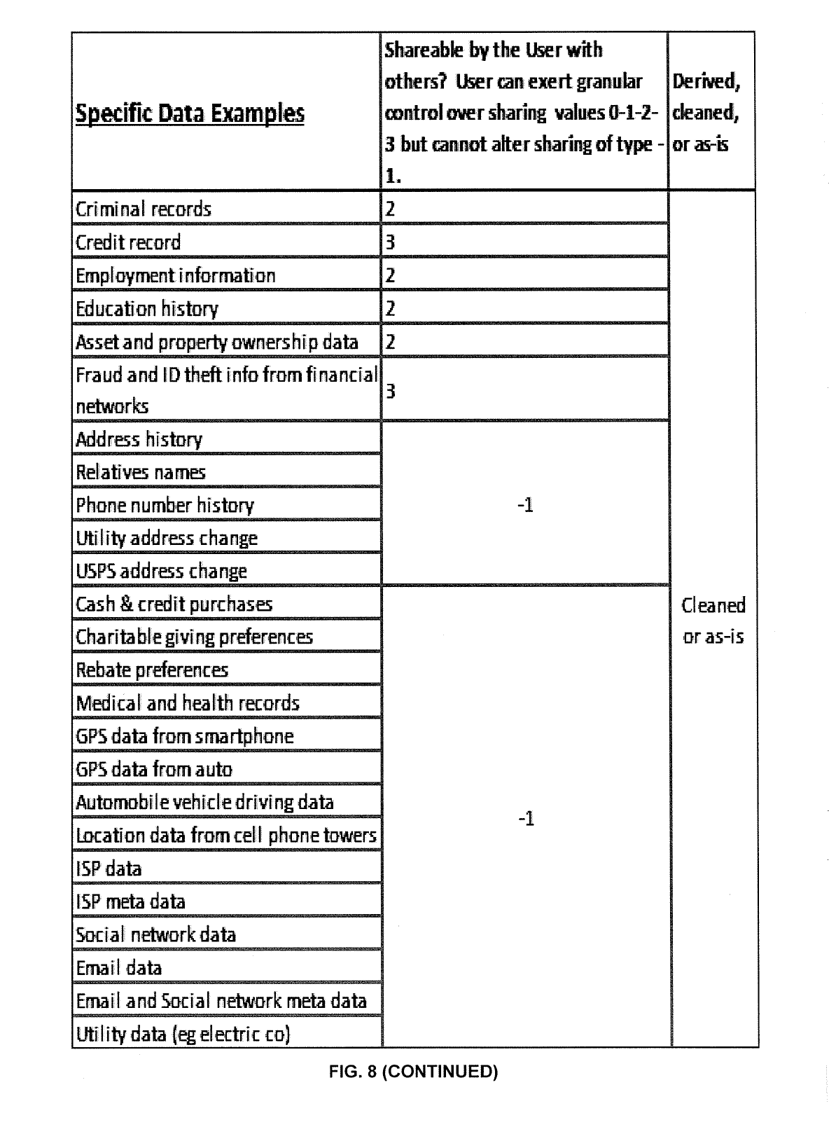

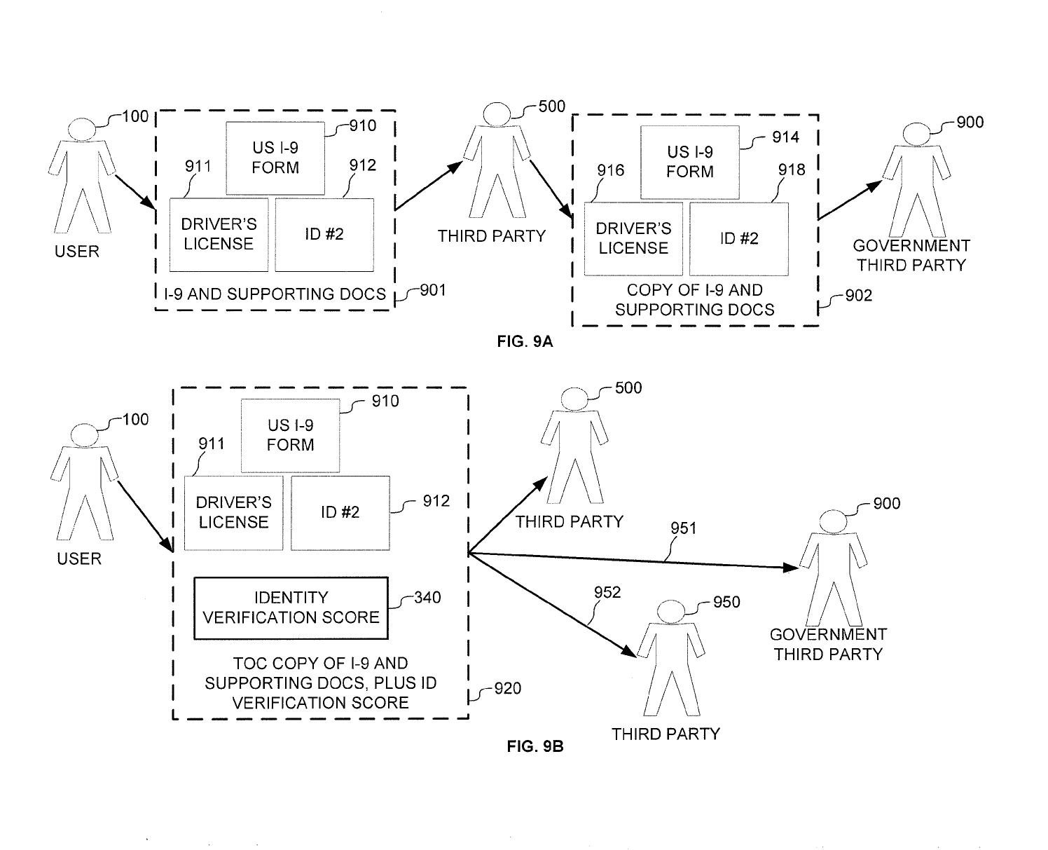

FIG. 8 gives specific examples of different data types based on categories in FIG. 7.

FIGS. 9A and 9B shows an example of TOC in use as a government I-9, and efficiencies obtained. FIG. 9A shows the traditional non-TOC method used by a user (or employee) 100 and a third party (or employer) 500 for completing the government-required I-9 form. The employee or potential employee completes a US I-9 form 910, and provides two supporting documents, typically a Driver's License 911 and a second ID (or ID#2) 912. The Employer 500 makes copies (or copy of I-9 and supporting docs) 902 of the original documents (or I-9 and supporting docs) 901 and stores the copies 902 in its own locations: US I-9 (copy) 914, driver's license (copy) 916, ID #2 (copy) 918. On occasion, a Government third-party 900 may demand to inspect the copies 902.

There are several problems with the existing process 9A. First, each employer 500 must store the copies 902, a cumbersome and expensive process. Second, the Employee 100 needs to provide the original documents 901 every time they get a new part-time or full-time job. Thirdly, there is no easy way for the employer 500 to ascertain whether the employee 100 is the person matching the original documents 901. Although systems such as E-Verify are provided by the US Government, they only answer the question “are the name and SSN used in documents 901 legitimate match” and do not answer “do the original documents 901 belong to the person who is being employed.” The problem with weak verification of the 901 documents is a weak link in potentially allowing terrorists into sensitive areas. The I-9 documents provide the basis for all other background checks and granting of access privileges, and in the current system in 9A the I-9 documents are a weak link.

FIG. 9B shows the TOC version of an I-9. The Employee (or User) 100 presents the documents (910, 911, and 912) to an employer, who scans them into the TOC system and enters them as First-party data, e.g. data submitted by the User but not corroborated. The employer does not have to store the copies of these documents. In addition, the Employee 100 passes through a standard TOC identity verification 340 which can ascertain the likelihood that the PII contained in documents 910, 911, and 912 match the actual Employee 100. Should the Government 900 require inspection of the documents, they are readily and cheaply available by simply issuing a blanket permission request to all Employees, allowing the Government to inspect the I-9 documents 951. Further, should the Employee 100 require a second I-9 due to a second employer 950, the User 100 can request that their existing I-9 and identity verification be forwarded 952 to the second employer (or third party) 950.

The TOC version of an I-9 is more efficient for the User 100, the Employers 500 and 950, and the Government 900. It is also substantially more resistant to identity fraud carried out by either illegal aliens or terrorists, due to the identity verification process 340.

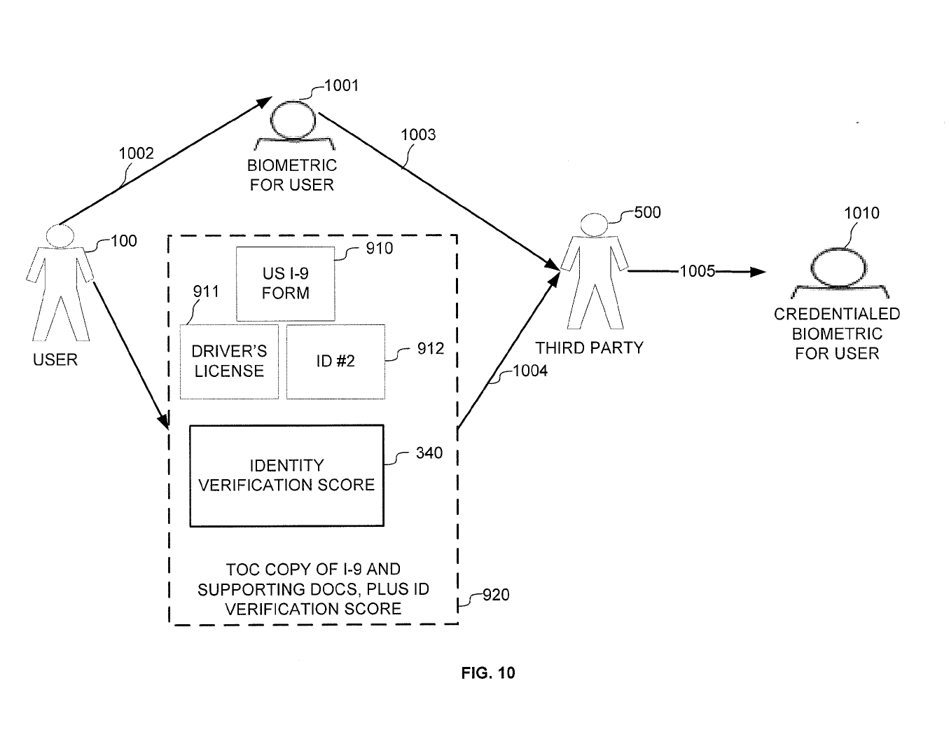

FIG. 10 shows how the TOC can integrate with biometric systems. User 100 either self-verifies themselves to a Third Party 500, or in more stringent cases uses the I-9 documents 910, 911 and 912. During the same time period, User 100 uses a biometric device, for example a retina scan or a fingerprint device 1001, to biometrically identify themselves 1002. Based on the user's self-verification and/or on the supporting I-9 documents, the Third Party 500, the Third Party 500 combines the self-verification 1004 and the biometric identity 1003 to issue a credential 1005, which is attached to the User 100 and by extension to the User's biometric profile 1010.

A flaw in the biometric system is that once an imposter, including illegal aliens and terrorists, successfully self-verifies themself and receives a credential attached to their biometric 1010, they receive a higher level of assumed verification due to the implicit trust placed in biometrics. This trust and higher verification level is inherently flawed. The user's identity has not been verified to any greater degree than that in FIG. 9A.

By contrast, if the TOC system is used in conjunction with biometric devices, then higher trust level and higher degree of identity verification can be assured. In this example, the self-verification documents are stored as part of the TOC, 920. In addition, an identity verification score 340 can be computed both initially and continuously thereafter. This ensures that the User 100 is who they say they are, and continuously checks that their identity verification score has not fallen below a critical Third-Party 500 established threshold. Thus, the biometric credential 1010, combined with a TOC and especially 340 identity verification score, ensures that the higher level of trust is warranted.

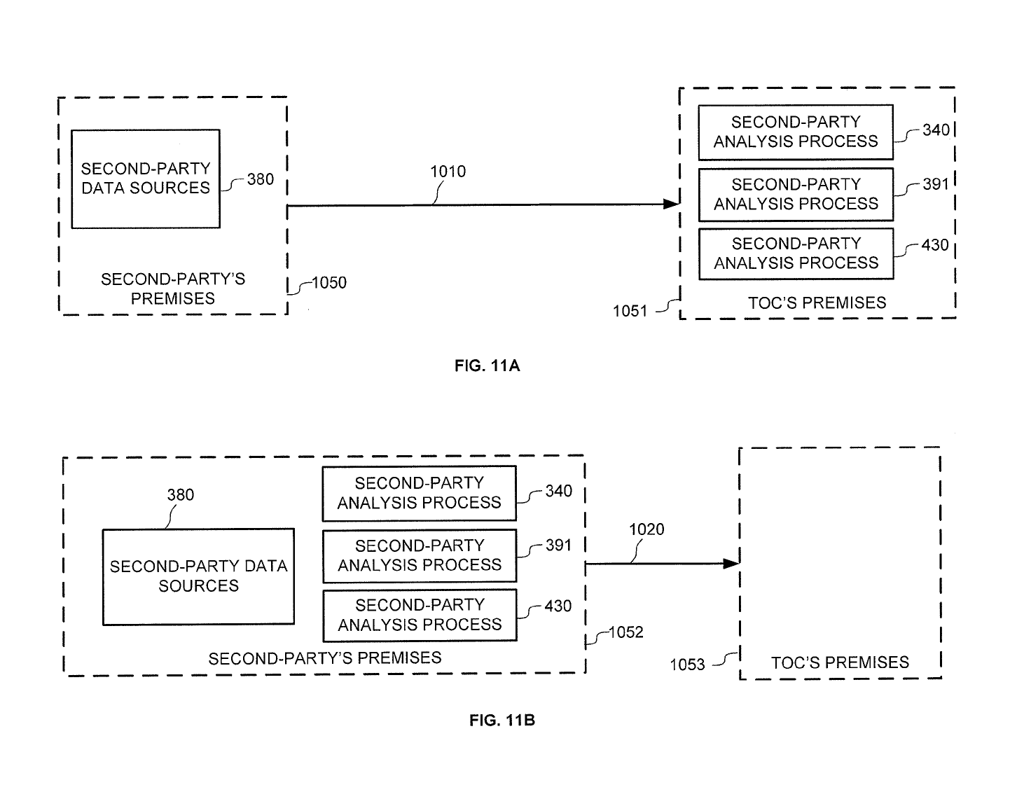

FIGS. 11a, 11b shows how second-party data sources 380 can be utilized even though the actual data may not be allowed to leave the second party's facilities. In one embodiment, FIG. 11a, second-party data 380 is transferred 1010 from the Second-party's premises 1050 to the TOC's premises 1051 in bulk e.g. via tape, FTP, disk, or in single quantities. Further analysis 340, 391, 430 takes place at the TOC facility.

FIG. 11b shows the case where the second party 380 may be required by law, by its own data source agreements, or by internal business requirement that its data be maintained on its premises 1052. In these cases, the TOC system can locate software elements 340, 391, 430 on the premises of the second party. In this case, only the pre-analyzed and less identifiable information is passed 1020 to the TOC 1053.

An example of this can be health care data. A healthcare provider with Electronic Medical Records (EMR) may determine that even with the Customer/Patient's authorization, that it is prevented by HIPPA from allowing such EMR out of its premises. In that case, from time to time, the TOC could query processes 340, 391 and 430, which are located on the Second parties' premises 1052 about a particular individual, e.g. Jane Doe. The data returned in 1020 would not violate HIPPA and would take the form of a question, e.g. “The last time you visited Dr. Kildare was (a) Never (b) 2 days ago (c) 2 months ago (d) 2 years ago.”

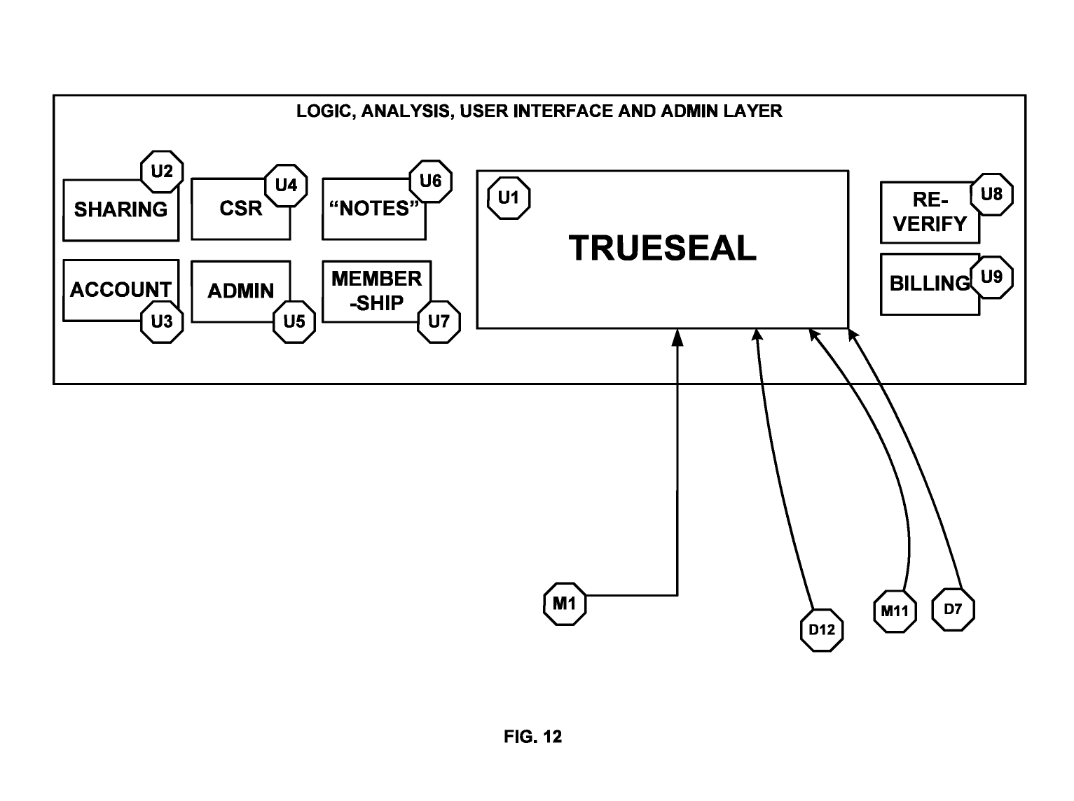

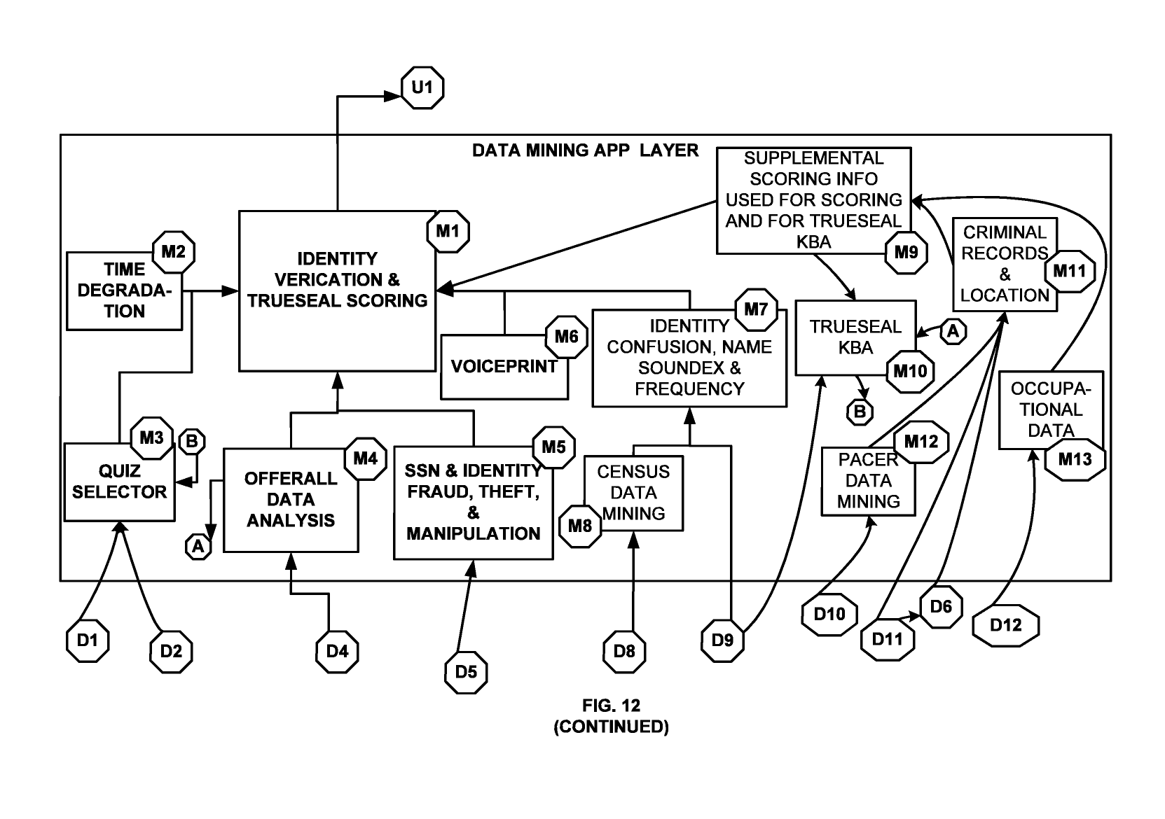

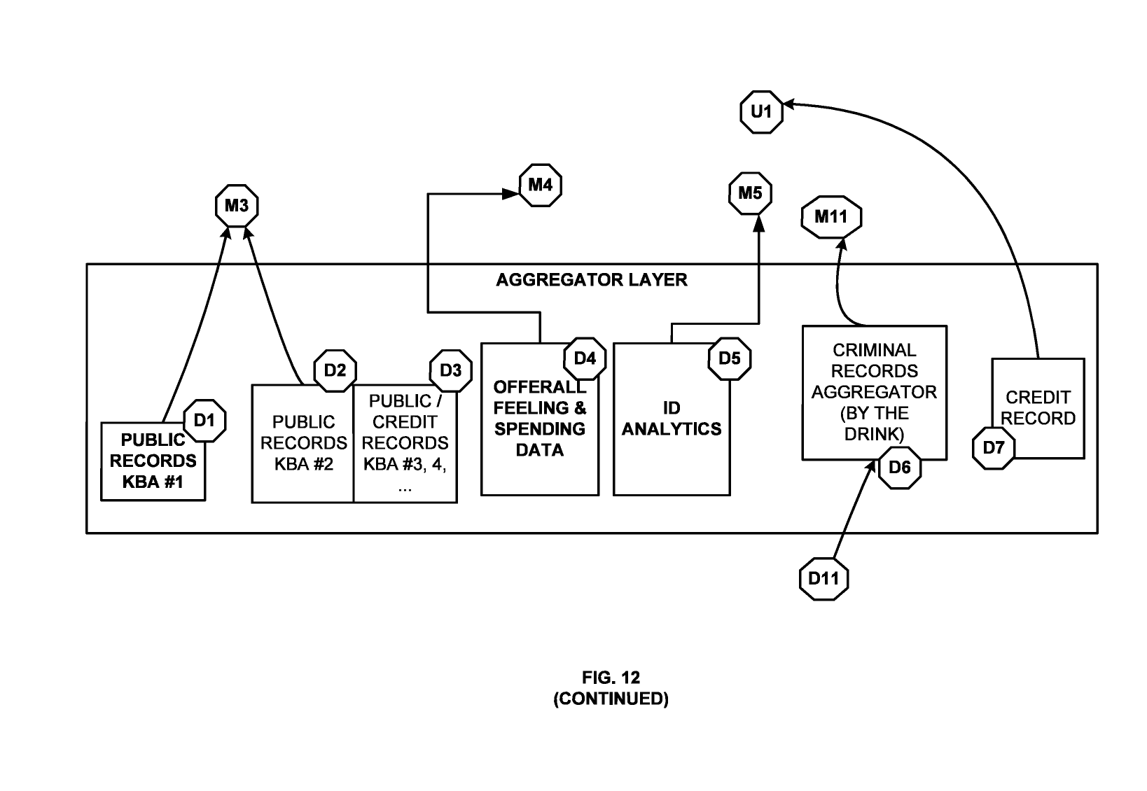

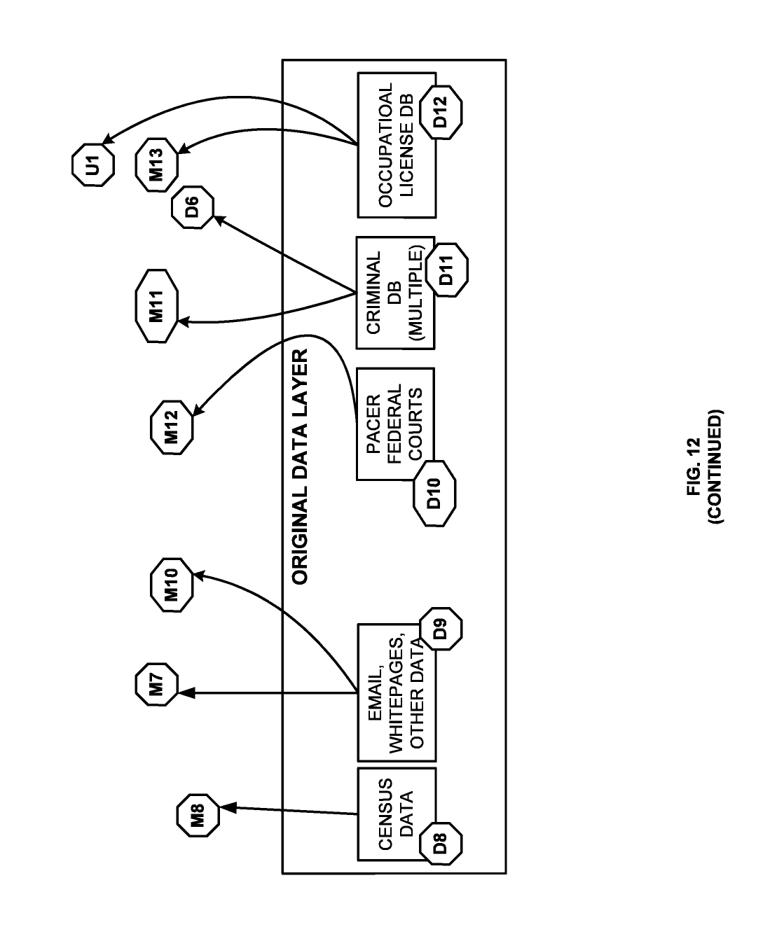

FIG. 12 shows various data and application layers for implementing various features of the embodiments discussed herein.

Although the present invention has been described herein with reference to a specific preferred embodiment, many modifications and variations therein will be readily occur to those skilled in the art. Accordingly, all such variations and modifications are included within the intended scope of the present invention as defined by the following claims.

It will be appreciated that the modules, processes, systems, and sections described above can be implemented in hardware, hardware programmed by software, software instructions stored on a nontransitory computer readable medium or a combination of the above. A system for identity verification credential with continuous verification and intention-based authentication, for example, can include using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the computer programming and network security arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and software for multi-level secure data import and export.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the invention.

What is claimed is:

1. A method for facilitating the authentication and verification of a user by creating and maintaining a true online credential (TOC), the method comprising:
receiving, at one of a plurality of network servers, a request from a client terminal to create a true online credential (TOC) for a user, said request containing a plurality of personally identifiable information of said user;
constructing, at one of said plurality of network servers, at least one knowledge-based-authentication (KBA) question based on said plurality of personally identifiable information and a plurality of third-party data sources;
transmitting, at one of said plurality of network servers, at least one Knowledge-based-authentication (KBA) question to said client terminal to be answered by said user;
receiving, at one of said plurality of network servers, a response from said client terminal to said at least one Knowledge-based-authentication (KBA) question;
computing, at one of said plurality of network servers, an identity verification score for said user;
transmitting, at one of said plurality of network servers, a request to said client terminal requesting permission from said user to access a plurality of second-party user data contained within a plurality of second-party data sources if said identity verification score exceeds a minimum identity verification score threshold.

2. The method of claim 1, further comprising
performing continuous identity verification at periodic intervals including:
constructing a plurality of new knowledge-based-authentication (KBA) questions based on said plurality of third-party data sources and said plurality of second-party data sources;
transmitting said plurality of new knowledge-based-authentication (KBA) questions to said user
receiving a plurality of new responses from said user;
recalculating said identity verification score, said recalculating based on in part said plurality of new responses received from said user.

3. The method of claim 1, wherein said plurality of personally identifiable information includes:
a full name;
a Social Security Number;
a Date of Birth;
an address;
and a phone number.

4. The method of claim 1, wherein said client terminal is a mobile phone.

5. The method of claim 1, wherein said client terminal is a computer.

6. The method of claim 1, wherein said client terminal is a mobile computer.

7. The method of claim 1, wherein said plurality of third-party data is maintained by a party not involved in a transaction between said user and a second party.

8. The method of claim 1, wherein said computing, at one of said plurality of network servers, an identity verification score for said user includes utilizing metadata or aggregated data from said second-party or third party in addition to said primary data.

9. The method of claim 2, wherein said performing continuous identity verification at periodic intervals further includes:
providing a reward to said user for continuously verifying their identity by providing said plurality of new responses.

10. The method of claim 2, wherein said plurality of second-party data is maintained at a second-party site, said second-party site being external to said plurality of network servers, and wherein constructing a plurality of new knowledge-based-authentication (KBA) questions based on said plurality of third-party data sources and said plurality of second-party data sources is partially carried out at said second-party site.

11. The method of claim 2, wherein recalculating said identity verification score includes degrading said identity verification score over time if said user fails to provide said plurality of new responses.

12. The method of claim 1, wherein said second-party data sources includes social networking data sources.

13. The method of claim 1, wherein said constructing, at one of said plurality of network servers, at least one knowledge-based-authentication (KBA) question based on said plurality of personally identifiable information and a plurality of third-party data sources includes heuristic decision making to select an appropriate third-party data source based on said plurality of personally identifiable information.

14. The method of claim 2, wherein said constructing a plurality of new knowledge-based-authentication (KBA) questions based on said plurality of third-party data sources and said plurality of second-party data sources includes Knowledge-Based-Authentication based on intention analysis derived from said second-party data sources.

15. A method of facilitating and sharing trust between a user and a third party, the method comprising:
creating a true online credential (TOC) for a user;
adding first, second, and third party data to said TOC;
analyzing said first, second, and third party data in said TOC to create a plurality of metadata stored within said TOC;
updating said metadata of the identity credential periodically; and
sharing selected first, second, and third party data and selected metadata in said TOC with a third party,
wherein said sharing of sharing selected first, second, and third party data and selected metadata in said TOC with a third party facilitates trust between said user and said third party.

16. The method of claim 15, wherein said creating a true online credential (TOC) for a user includes coupling said TOC with a biometric identity applications.

17. The method of claim 15, wherein said updating said metadata of the identity credential periodically includes providing rewards to encourage said user to continuously verify their identity.

18. The method of claim 15, wherein said creating a true online credential (TOC) for a user includes Knowledge-Based-Authentication based on intention analysis derived from second-party data.

19. The method of claim 15, wherein said creating a true online credential (TOC) for a user includes Knowledge-Based-Authentication based on heuristic decision making analysis.
